(19) United States
(12) Patent Application Publication
(10) Pub. No.: US 2024/0015615 A1
(43) Pub. Date: Jan. 11, 2024

(54) MECHANISMS FOR LAYER 1 (L1) MEASUREMENTS ON NEIGHBOR CELL

(71) Applicant: Apple Inc., Cupertino, CA (US)

(72) Inventors: Qiming LI, Beijing (CN); Manasa RAGHAVAN, Sunnyvale, CA (US); Xiang CHEN, Campbell, CA (US); Huaning NIU, San Jose, CA (US); Jie CUI, San Jose, CA (US); Dawei ZHANG, Saratoga, CA (US); Yang TANG, San Jose, CA (US); Yushu ZHANG, Beijing (CN)

(73) Assignee: Apple Inc., Cupertino, CA (US)

(21) Appl. No.: 17/440,117

(22) PCT Filed: Mar. 29, 2021
(86) PCT No.: PCT/CN2021/083499

§ 371 Date: Oct. 6, 2022

(51) Int. Cl. H04W 36/00

(52) U.S. Cl. CPC H04W 36/00835; H04W 36/0085

(57) ABSTRACT

Some aspects of this disclosure include apparatuses and methods for implementing mechanisms for performing L1-RSRP (Layer 1 Reference Signal Received Power) measurements and/or L1-SINR (Layer 1 Signal-to-Noise and Interference Ratio) measurements on a neighbor cell. For example, some aspects of this disclosure relate to an electronic device. The electronic device includes a transceiver configured to communicate with a serving cell and a neighbor cell and a processor communicatively coupled to the transceiver. The processor determines a measurement period for a Layer 1 (L1) measurement on the neighbor cell and receives, using the transceiver, a resource from the neighbor cell during the measurement period. The processor further performs the L1 measurement on the neighbor cell using the received resource from the neighbor cell.

### BACKGROUND

### Field

The described aspects generally relate to Layer 1 (L1) measurements in wireless communications. For example, the aspects of this disclosure relate to mechanisms for an electronic device (for example, a user equipment (UE)) to perform L1-RSRP (L1-Reference Signal Received Power) measurements and/or L1-SINR (L1-Signal-to-Noise and Interference Ratio) measurements on a neighbor cell.

### Related Art

While a user equipment (UE) is connected to a base station (for example, an evolved Node B (eNB)) in one cell (e.g., a serving cell) to communicate through the wireless network associated to that base station, the UE can actively detect and/or measure other carriers on the serving cell and/or detect and/or measure other cells (e.g., neighbor cells). In some examples, the UE can perform L1-RSRP measurements and/or L1-SINR measurements on the serving cell. However, the UE does not perform L1-RSRP measurements and/or L1-SINR measurements on the serving cell.

### SUMMARY

Some aspects of this disclosure include apparatuses and methods for implementing mechanisms for performing L1-RSRP measurements and/or L1-SINR measurements on a neighbor cell. In some aspects, the L1-RSRP measurements can be performed using one or more of Channel State Information Reference Signal (CSI-RS) based measurements or Synchronization Signal Block (SSB) based measurements. Additionally, or alternatively, the L1-SINR measurements can be performed using one or more of CSI-RS based measurements or SSB based measurements.

Some aspects of this disclosure relate to an electronic device. The electronic device includes a transceiver configured to communicate with a serving cell and a neighbor cell and a processor communicatively coupled to the transceiver. The processor determines a measurement period for a Layer 1 (L1) measurement on the neighbor cell and receives, using the transceiver, a resource from the neighbor cell during the measurement period. The processor further performs the L1 measurement on the neighbor cell using the received resource from the neighbor cell.

Some aspects of this disclosure relate to an electronic device of a serving cell. The electronic device includes a transceiver configured to communicate with a user equipment (UE) and a processor communicatively coupled to the transceiver. The processor transmits one or more parameters associated with the serving cell to the UE. The one or more parameters are used to determine a measurement period for a Layer 1 (L1) measurement on a neighbor cell during the measurement period and using a resource from the neighbor cell.

Some aspects of this disclosure relate to a method. The method includes determining, by a user equipment (UE) that communicates with a serving call, a measurement period for a Layer 1 (L1) measurement on a neighbor cell. The method further includes receiving, by the UE, a resource from the neighbor cell during the measurement period. The method also includes performing, by the UE, the L1 measurement on the neighbor cell using the received resource from the neighbor cell.

Some aspects of this disclosure relate to a non-transitory computer-readable medium storing instructions. When the instructions are executed by a processor of a user equipment (UE) that communicates with a serving call, the instructions cause the processor to perform operations including determining a measurement period for a Layer 1 (L1) measurement on a neighbor cell and receiving a resource from the neighbor cell during the measurement period. The operations further include performing the L1 measurement on the neighbor cell using the received resource from the neighbor cell.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system implementing mechanisms for performing L1-RSRP measurements and/or L1-SINR measurements on a neighbor cell, according to some aspects of the disclosure.

FIG. 2 illustrates a block diagram of an example system of an electronic device of implementing mechanisms for performing L1-RSRP measurements and/or L1-SINR measurements on a neighbor cell, according to some aspects of the disclosure.

FIG. 3 illustrates an exemplary intra-frequency CSI-RS based L1 measurement (e.g., L1-SINR measurement and/or L1-RSRP measurement) in a neighbor cell in FR1, according to some aspects of this disclosure.

FIG. 4 illustrates an exemplary intra-frequency SSB based L1-RSRP measurement in FR1, according to some aspects of this disclosure.

FIGS. 5A-5I illustrate exemplary intra-frequency CSI-RS based L1 measurements in FR2, according to some aspects of this disclosure.

FIGS. 6A-6H illustrate exemplary intra-frequency SSB based L1-RSRP measurements in FR2, according to some aspects of this disclosure.

FIG. 7 illustrates an example method for a system (for example a user equipment (UE)) supporting mechanisms for performing L1-RSRP measurements and/or L1-SINR measurements on a neighbor cell, according to some aspects of this disclosure.

FIG. 8 is an example computer system for implementing some aspects or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects of this disclosure include apparatuses and methods for implementing mechanisms for performing L1-RSRP measurements and/car L1-SINR measurements on a neighbor cell. In some aspects, the L1-RSRP measurements can be performed using one or more of CSI-RS based measurements or SSB based measurements. Additionally, or alternatively, the L1-SINR measurements can be performed using one or more of CSI-RS based measurements or SSB based measurements.

According to some aspects, the L1-RSRP measurements and/or L1-SINR measurements on the neighbor cell of this disclosure can be performed by a UE that operates according to Release 17 (Rel-17) new radio (NR) of 5^{th} generation (5G) wireless technology for digital cellular networks as defined by 3rd Generation Partnership Project (3GPP). The UE operating the Release 15 (Rel-15) and Release 16 (Rel-16) (or earlier) does not perform the L1-RSRP measurements and/or L1 -SINR measurements on the neighbor cell. However, the aspects of this disclosure are not limited to these examples, and the L1-RSRP measurements and/or L1-SINR measurements on the neighbor cell of this disclosure can be extended to future releases of 3GPP.

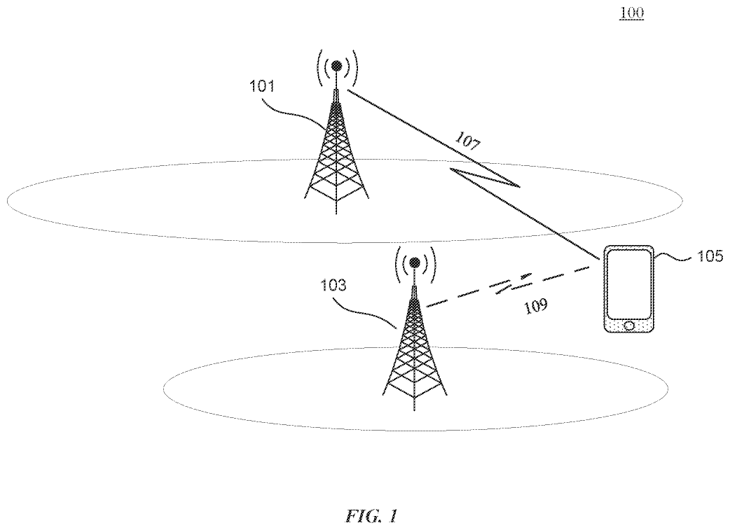

FIG. 1 illustrates an example system 100 implementing mechanisms for performing L1-RSRP measurements and/or L1-SNR measurements on a neighbor cell, according to some aspects of the disclosure. Example system 100 is provided for the purpose of illustration only and does not limit the disclosed aspects. System 100 may include, but is not limited to, network nodes (for example, base stations such as eNBs) 101 and 103 and electronic device (for example, a UE) 105. Electronic device 105 (hereinafter referred to as UE 105) can include an electronic device configured to operate based on a wide variety of wireless communication techniques. These techniques can include, but are not limited to, techniques based on 3rd Generation Partnership Project (3GPP) standards. For example, UE 105 can include an electronic device configured to operate using Rel-17 or later. UE 105 can include, but is not limited to, as wireless communication devices, smart phones, laptops, desktops, tablets, personal assistants, monitors, televisions, wearable devices, Internet of Things (IoTs), vehicle's communication devices, and the like. Network nodes 101 and 103 (herein referred to as base stations or cells) can include nodes configured to operate based on a wide variety of wireless communication techniques such as, but not limited to, techniques based on 3GPP standards. For example, base stations 101 and 103 can include nodes configured to operate using Rel-17 or later.

According to some aspects, UE 105 and base stations 101 and 103 are configured to implement mechanisms for UE 105 to perform L1-RSRP measurements and/or L1-SINR measurements on a neighbor cell (e.g., base station 103). In some aspects, UE 105 is configured to perform the L1-RSRP measurements using one or more of CSI-RS based measurements or SSB based measurements. Additionally, or alternatively, UE 105 is configured to perform the L1-SINR measurements using one or more of CSI-RS based measurements or SSB based measurements.

According to some aspects, UE 105 can be connected to and can be communicating with base station 101 (e.g., the serving cell) using carrier 107. According to some aspects, carrier 107 can include one carrier. Additionally, or alternatively, carrier 107 can include two or more component carriers (CC). In other words, UE 105 can implement carrier aggregation (CA). For example, UE can use multiple carriers for communication with base station 101.

According to some aspects, UE 105 can measure one or more carriers (e.g., carrier 107) used for communication with base station 101 (e.g., the serving cell) to determine channel quality information associated with carrier 107. Additionally, or alternatively, UE 105 can detect and measure one or more carriers (for example, carriers 109) associated with base station 103 (e.g., the neighbor cell) to determine channel quality information associated with carrier 109.

According to some aspects, UE 105 can perform L1 measurements on carrier 109 associated with base station 103 (neighbor cell). In some examples, the L1 measurements can include measurements performed and/or reported by UE 105 at Layer 1 (e.g., Physical Layer). The L1 measurements can include measurements at beam level and can include measurements for procedures for which UE 105 can react with minimal delay. As discussed in more detail below, L1 measurements can include L1-RSRP measurements and/or L1-SINR measurements.

In some aspects, UE 105 can perform the L1-RSRP measurements using one or more of CSI-RS based measurements or SSB based measurements. Additionally, or alternatively, UE 105 can perform the L1-SINR measurements using one or more of CSI-RS based measurements or SSB based measurements.

In some aspects, UE 105 can perform the CSI-RS based measurements (for L1-RSRP or L1-SINR) in Frequency Range 1 (FR1). Additionally, or alternatively, UE 105 can perform the CSI-RS (for L1-RSRP or L1-SINR) based measurements in Frequency Range 2 (FR2). In some aspects, UE 105 can perform the SSB based measurements (for L1-RSRP air L1-SINR) in FR1. Additionally, or alternatively, UE 105 can perform the SSB (for L1-RSRP or L1-SINR) based measurements FR2.

In some aspects, the CSI-RS based L1-RSRP measurement can include using CSI-RS for measuring L1-RSRP. For example, the CSI-RS based L1-RSRP measurement can include measuring and using power contributions (or their average) of resources (e.g., resource elements) that carry CSI-RS for the L1-RSRP measurement. In some examples, UE 105 can measure and use the power contributions (or their average) of resources (e.g., resource elements) in carrier 109 that carry CSI-RS for the L1-RSRP measurement.

In some aspects, the CSI-RS based L1-SINR measurement can include using CSI-RS for measuring L1-SINR. For example, the CSI-RS based L1-SINR measurement can include measuring and using SINR associated with resources (e.g., resource elements) carrying CRSI-RS. For example, CSI-RS based L1-SINR measurement can include measuring power contributions (or their average) of the resources divided by the SINR (or its average) of the resources. In some examples, UE 105 can measure the power contributions (or their average) of the resources in carrier 109 and divide the measured power contribution by the SINR (or its average) of the resources in carrier 109.

According to some aspects, the SSB based L1-RSRP measurement can include using Secondary Synchronization Signal (SSS) for measuring L1-RSRP. For example, the SSB based L1-RSRP measurement can include measuring and using power contributions (or their average) of resources (e.g., resource elements) that carry SSS. In some examples, UE 105 can measure and use the power contributions (or their average) of resources (e.g., resource elements) in carrier 109 that carry SSS.

According to some aspects, the SSB based L1-SINR measurement can include using SSS for measuring L1-SINR. For example, the SSB based L1-SINR measurement can include measuring and using SINR associated with resources (e.g., resource elements) carrying SSS. For example, the SSB based L1-SINR measurement can include measuring power contributions (or their average) of the resources divided by the SINR (or its average) of the resources. In some examples, UE 105 can measure the power contributions (or their average) of the resources in carrier 109 divided by the SINR (or its average) of the resources in carrier 109.

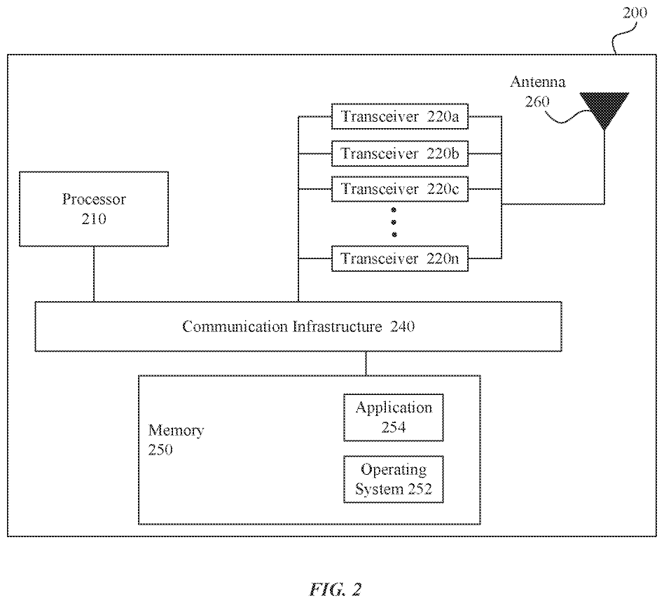

FIG. 2 illustrates a block diagram of an example system 200 of an electronic device implementing mechanisms for performing L1-RSRP measurements and/or L1-SINR measurements on a neighbor cell, according to some aspects of the disclosure. System 200 may be any of the electronic devices (e.g., base stations 101, 103, UE 105) of system 100. System 200 includes processor 210, one or more transceivers 220a-220n, communication infrastructure 240, memory 250, operating system 252, application 254, and antenna 260. Illustrated systems are provided as exemplary parts of system 200, and system 200 can include other circuit(s) and subsystem(s). Also, although the systems of system 200 are illustrated as separate components, the aspects of this disclosure can include any combination of these, less, or more components.

Memory 250 may include random access memory (RAM) and/or cache, and may include control logic (e.g., computer software) and/or data. Memory 250 may include other storage devices or memory such as, but not limited to, a hard disk drive and/or a removable storage device/unit. According to some examples, operating system 252 can be stored in memory 250. Operating system 252 can manage transfer of data from memory 250 and/or one or more applications 254 to processor 210 and/or one or more transceivers 220a-220n. In some examples, operating system 252 maintains one or more network protocol stacks (e.g., Internet protocol stack, cellular protocol stack, and the like) that can include a number of logical layers. At corresponding layers of the protocol stack, operating system 252 includes control mechanism and data structures to perform the functions associated with that layer.

According to some examples, application 254 can be stored in memory 250. Application 254 can include applications (e.g., user applications) used by wireless system 200 and/or a user of wireless system 200. The applications in application 254 can include applications such as, but not limited to, Siri™, FaceTime™, radio streaming, video streaming, remote control, and/or other user applications.

System 200 can also include communication infrastructure 240. Communication infrastructure 240 provides communication between, for example, processor 210, one or more transceivers 220a-220n, and memory 250. In some implementations, communication infrastructure 240 may be a bus. Processor 210 together with instructions stored in memory 250 performs operations enabling system 200 of system 100 to implement mechanisms for exchanging a searcher number for carrier/cell detection and measurement, as described herein. Additionally, or alternatively, one or more transceivers 220a-220n perform operations enabling system 200 of system 100 to implement mechanisms for performing L1-RSRP measurements and/or L1-SINR measurements on a neighbor cell, as described herein.

One or more transceivers 220a-220n transmit and receive communications signals that support mechanisms for performing L1-RSRP measurements and/or L1-SINR measurements on a neighbor cell, according to some aspects, and may be coupled to antenna 260. Antenna 260 may include one or more antennas that may be the same or different types. One or more transceivers 220a-220n allow system 200 to communicate with other devices that may be wired and/or wireless. In some examples, one or more transceivers 220a-220n can include processors, controllers, radios, sockets, plugs, buffers, and like circuits/devices used for connecting to and communication on networks. According to some examples, one or more transceivers 220a-220n include one or more circuits to connect to and communicate on wired and/or wireless networks.

According to some aspects, one or more transceivers 220a-220n can include a cellular subsystem, a WLAN subsystem, and/or a Bluetooth™ subsystem, each including its own radio transceiver and protocol(s) as will be understood by those skilled arts based on the discussion provided herein. In some implementations, one or more transceivers 220a-220n can include more or fewer systems for communicating with other devices.

In some examples, one or more transceivers 220a 220n can include one or more circuits (including a WLAN transceiver) to enable connection(s) and communication over WLAN networks such as, but not limited to, networks based on standards described in IEEE 802.11. Additionally, or alternatively, one or more transceivers 220a-220n can include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, transceiver 220n can include a Bluetooth™ transceiver.

Additionally, one or more transceivers 220a-220n can include one or more circuits (including a cellular transceiver) for connecting to and communicating on cellular networks. The cellular networks can include, but are not limited to, 3G/4G/5G networks such as Universal Mobile Telecommunications System (UMTS), Long-Term Evolution (LTE), and the like. For example, one or more transceivers 220a-220n can be configured to operate according to one or more of Rel-15, Rel-16, Rel-17, or later of 3GPP standard.

According to some aspects, processor 210, alone or in combination with computer instructions stored within memory 250, and/or one or more transceiver 220a-220n, implements L1-RSRP measurements and/or L1-SINR measurements on a neighbor cell as discussed herein. For example, transceiver 220a can enable connection(s) and communication over a first carrier (for example, carrier 107 of FIG. 1). In this example, transceiver 220a and/or transceiver 220b can enable detecting and/or measuring a second carrier (for example, carrier 109 of FIG. 1). Additionally, or alternatively, wireless system 200 can include one transceiver configured to operate at different carriers. Processor 210 can be configured to control the one transceiver to switch between different carriers, according to some examples. Although the operations discussed herein are discussed with respect to processor 210, it is noted that processor 210, alone or in combination with computer instructions stored within memory 250, and/or one or more transceiver 220a-220n, can implement these operations.

In some examples, the current L1-SINR measurement requirements for the serving cell (e.g., base station 101) is discussed in 3GPP Technical Specification (TS) 38.133 clause 9.8. 3GPP TS38.133 is incorporated herein in its entirety. The current 3GPP TS38.133 clause 9.8 only applies for measurement on the serving cell (e.g., base station 101). Some aspects of this disclosure are directed to extending this clause to the L1-SINR measurement requirements for the neighbor cell (e.g., base station 103) as provided below:

### 9.8 L1-SINR Measurements for Reporting

### 9.8.1 Introduction

When configured by the network, the UE shall be able to perform L1-SINR measurements with the measurement resources configured as the selection of:
CSI-RS based CMR and no dedicated IMR configured;
SSB based CMR and dedicated IMR configured;
CSI-RS based CMR and dedicated IMR configured.
   The measurements shall be performed for a serving cell or neighbor cells, including PCell, PSCell, or SCell, on the resources configured for L1-SINR measurements within the active BWP.
   The UE shall be able to measure all CSI-RS resources and/or SSB resources and/or CSI-IM resources of the nzp-CSI-RS-ResourceSet and/or csi-SSB-ResourceSet and/or CSI-IM-ResourceSet within the CSI-ResourceConfig settings for L1-SINR and measure interference on corresponding NZP CSI-RS or CSI-IM resources if configured, provided that the number of resources does not exceed the UE capability indicated by beamManagementSSB-CSI-RS, and the number of resources in neighbor cells does not exceed the UE capability indicated by NeighborCellbeamManagementSSB-CSI-RS.
   The UE shall report the measurement quantity (reportQuantity) and send periodic, semi-persistent or aperiodic reports, according to the reportConfigType according to the CSI reporting configuration(s) (CSI-ReportConfig) for the active BWP.

Here, PCell is Primary Cell, SCell is Secondary Cell, and PSCell is Primary SCell. Also, IMR is interference Measurement Resource, CMR is Channel Measurement Resource, and BWP is Bandwidth.

According to some aspects, NeighborCellbeamManagementSSB-CSI-RS is a parameter defined by, for example, the network for UE capability as a limit for the number of resources (e.g., CSI-RS resources and/or SSB resources and/or CSI-IM resources) in the neighbor cell for the UE to measure.

In some examples, the current L1-RSRP measurement requirements for the serving cell (e.g., base station 101) is discussed in 3GPP TS38.133 clause 9.5. The current 3GPP TS38.133 clause 9.5 only applies for measurement on the serving cell (e.g., base station 101). Some aspects of this disclosure are directed to extending this clause to the L1-RSRP measurement requirements for the neighbor cell base station 103) as provided below:

### 9.5 L1-RSRP Measurements for Reporting

### 9.5.1 Introduction

When configured by the network, the UE shall be able to perform L1-RSRP measurements of configured CSI-RS, SSB or CSI-RS and SSB resources for L1-RSRP. The measurements shall be performed for either a serving cell or a neighbor cell, including PCell, PSCell, or SCell, on the resources configured for L1-RSRP measurements.
The UE shall be able to measure all CSI-RS resources and/or SSB resources of the nzp-CSI-RS-ResourceSet and/or csi-SSB-ResourceSet within the CSI-ResourceConfig settings configured for L1-RSRP, provided that the number of resources in serving cells does not exceed the UE capability indicated by beamManagementSSB-CSI-RS and the number of resources in neighbor cells does not exceed the UE capability indicated by NeighborCellbeamManagementSSB-CSI-RS.
The UE shall report the measurement quantity (reportQuantity) and send periodic, semi-persistent or aperiodic reports, according to the reportConfigType according to the CSI reporting configuration(s) (CSI-ReportConfig).
In EN-DC and NE-DC operation, when the UE is configured to perform E-UTRA SRS carrier-based switching an additional delay can be expected in FR1 if the UE is capable of per-FR gap, or an additional delay can be expected in both FR1 and FR2 if the UE is not capable of per-FR gap.

According to some aspects, NeighborCellbeamManagementSSB-CSI-RS is a parameter defined by, for example, the network for UE capability as a limit for the number of resources (e.g., CSI-RS resources and/or SSB resources and/or CSI-IM resources) in the neighbor cell for the UE to measure.

According to some aspects, the L1-SINR measurement can be split into two categories—intra-frequency L1-SINR measurement on neighbor cells and inter-frequency L1-SINR measurement on neighbor cells.

According to some examples, the definition of intra/inter-frequency neighbor cell L1-SINR measurement with SSB based CMR and dedicated IMR can be captured in 3GPP TS38.133, For example:

A measurement is defined as an intra-frequency L1 SINR measurement with SSB based CMR and dedicated IMR provided that:
the SCS of SSB on the neighbor cell configured as CMR for L1 SINR computation is the same as the SCS of SSB resources on the serving cell indicated for measurement, and
the centre frequency of SSB on the neighbour cell configured as CMR for L1 SINR computation is the same as the centre frequency of SSB on the serving cell indicated for measurement.
the centre frequency of CSI-RS resources on the neighbour cell configured as CMR and IMR (if configured) for L1 SINR computation is the same as the centre frequency of CSI-RS resources on the serving cell indicated for measurement.

The SCS of the CSI-RS resources on neighbor cell configured as IMR for L1 SINR computation is the same as the SCS of active BWP (PDCCH/PDSCH/CSI-RS) on the serving cell, and
the CP type of CSI-RS resources on neighbor cell configured as IMR for L1 SINR computation is the same as the CP type of active BWP (PDCCH/PDSCH/CSI-RS) on the serving cell, and
   It is applied for SCS=60 KHzs
      A measurement is defined as an inter-frequency L1 SINR measurement with SSB based CMR and dedicated IMR provided it is not defined as an intra-frequency L1 SINR measurement according to above criteria.

In this example, the intra-frequency L1-SNR measurement with SSB based CMR and dedicated IMR can be defined when the Subcarrier Spacing (SCS) of the SSB resource(s) on the neighbor cell (e.g., base station 103) configured as the CMR for the L1-SINR measurement is the same as the SCS of the SSB resource(s) on the serving cell (e.g., base station 101) indicated for the L1-SINR measurement and the center of frequency of the SSB resource(s) on the neighbor cell configured as the CMR for the L1-SINR measurement is the same as the center of frequency of the SSB resource(s) on the serving cell indicated for the L1-SINR measurement.

Additionally, or alternatively, the intra-frequency L1-SINR measurement with SSB based CMR and dedicated IMR can be defined when the centre frequency of CSI-RS resources on the neighbor cell (e.g., base station 103) configured as CMR and IMR (if configured) for L1 SINR computation is the same as the centre frequency of CSI-RS resources on the serving cell indicated for measurement. Additionally, or alternatively, the SCS of the CSI-RS resource(s) on the neighbor cell (e.g., base station 103) configured as the IMR for the L1-SINR measurement is the same as the SCS of an active BWP on the serving cell, the Cyclic Prefix (CP) type of the CSI-RS resource(s) on the neighbor cell (e.g., base station 103) configured as the IMR for the L1-SINR measurement is the same as the CP type of the active BWP on the serving cell, and the L1-SINR measurement is applied to SCS of 60 KHz. In some examples, the BWP is associated with PDCCH (Physical Downlink Control Channel), PDSCH (Physical Downlink Shared Channel), and/or CSI-RS.

Additionally, or alternatively, a measurement can be defined as an inter-frequency L1-SINR measurement with SSB based CMR and dedicated IMR provided it is not defined as an intra-frequency L1-SINR measurement as discussed above.

In some examples, the definition of intra/inter-frequency neighbor cell L1-SINR measurement with CSI-RS based CMR can be captured in 3GPP TS38.133. For example:

A measurement is defined as an intra-frequency L1 SINR measurement with CSI-RS based CMR provided that:
the SCS of CSI-RS resources on the neighbor cell configured as CMR and IMR (if configured) for L1 SINR computation is the same as the SCS of active BWP (PDCCH/PDSCH/CSI-RS) on the serving cell, and
the centre frequency of CSI-RS resources on the neighbour cell configured as CMR and IMR (if configured) for L1 SINR computation is the same as the centre frequency of the centre frequency of CSI-RS resources on the serving cell indicated for measurement.
the CP type of CSI-RS resources on neighbor cell configured as CMR and IMR (if configured) for L1 SINR computation is the same as the CP type of active BWP (PDCCH/PDSCH/CSI-RS) on the serving cell, and
   It is applied for SCS=60 KHzs
      A measurement is defined as an inter-frequency L1 SINR measurement with CSI-RS based CMR provided it is not defined as an intra-frequency L1 SINR measurement according to above criteria.

In this example, the intra-frequency L1-SNR measurement with CSI-RS based CMR can be defined when the SCS of the CSI-RS resource(s) on the neighbor cell (e.g., base station 103) configured as the CMR and IMR (as configured) for the L1-SINR measurement is the same as the SCS of the active BWP on the serving cell (e.g., base station 101) and the center of frequency of the CSI-RS resource(s) on the neighbor cell (e.g., base station 103) configured as the CMR and IMR (if configured) for the L1-SINR measurement is the same as the center of frequency of the CSI-RS resource(s) on the serving cell (e.g., base station 101) indicated for the L1-SINR measurement.

Additionally, or alternatively, the intra-frequency L1-SINR measurement with CSI-RS based CMR can be defined when the CP type of the CSI-RS resource(s) on the neighbor cell (e.g., base station 103) configured as the CMR and IMR (if configured) for the L1-SINR measurement is the same as the CP type of the active BWP on the serving cell (e.g., base station 101) and the L1-SINR measurement is applied to SCS of 60 KHz. In some examples, the BWP is associated with PDCCH (Physical Downlink Control Channel), PDSCH (Physical Downlink Shared Channel), and/or CSI-RS.

Additionally, or alternatively, a measurement can be defined as an inter-frequency L1-SINR measurement with CSI-RS based CMR provided it is not defined as an intra-frequency L1-SINR measurement as discussed above.

According to some aspects, the L1-RSRP measurement can be split into two categories—intra-frequency L1-RSRP measurement on neighbor cells and inter-frequency L1-RSRP measurement on neighbor cells.

According to some examples, the definition of SSB based intra/inter-frequency neighbor cell L1-RSRP measurement can be captured in 3GPP TS38.133. For example:

A measurement is defined as a SSB based intra-frequency L1 measurement provided that:
the SCS of SSB on the neighbour cell configured for L1 measurement is the same as the SCS of SSB resources on the serving cell indicated for measurement, and
the centre frequency of SSB on the neighbour cell configured for L1 measurement is the same as the centre frequency of SSB on the serving cell indicated for measurement. A measurement is defined as an SSB based inter-frequency L1 measurement provided it is not defined as an intra-frequency L1 measurement according to above criteria.

In this example, the SSB based intra-frequency L1-RSRP measurement can be defined when the SCS of the SSB resource(s) on the neighbor cell (e.g., base station 103) configured for L1-RSRP measurement is the same as the SCS of the SSB resource(s) on the serving cell (e.g., base station 101) indicated for the L1-RSRP measurement and the center of frequency of the SSB resource(s) on the neighbor cell (e.g., base station 103) configured for L1-RSRP measurement is the same as the center for frequency of the SSB resource(s) on the serving cell indicated for L1-RSRP measurement.

Additionally, or alternatively, a measurement can be defined as an SSB based inter-frequency L1-RSRP measurement provided it is not defined as an intra-frequency L1-RSRP measurement as discussed above.

According to some examples, the definition of CSI-RS based intra/inter-frequency neighbor cell L1-RSRP measurement can be captured in 3GPP TS38.133. For example:

A measurement is defined as a CSI-RS based intra-frequency L1 RSRP measurement provided that:
the SCS of CSI-RS resources on the neighbour cell configured for L1 RSRP measurement is the same as the SCS of CSI-RS resources on the serving cell indicated for measurement, and
the CP type of CSI-RS resources on neighbour cell configured for L1 RSRP measurement is the same as the CP type of CSI-RS resources on the serving cell indicated for measurement, and
   It is applied for SCS=60 KHzs
the centre frequency of CSI-RS resources on the neighbour cell configured for L1 RSRP measurement is the same as the centre frequency of CSI-RS resources on the serving cell indicated for measurement.
   A CSI-RS based neighbor cell L1 RSRP measurement is defined as an CSI-RS based inter-frequency L1 RSRP measurement provided it is not defined as an intra-frequency L1 RSRP measurement according to above criteria.

In this example, the CSI-RS based intra-frequency L1-RSRP measurement can be defined when the SCS of CSI-RS resource(s) on the neighbor cell (e.g., base station 103) configured for L1-RSRP measurement is the same as the SCS of CSI-RS resource(s) on the serving cell (e.g., base station 101) indicated for L1-RSRP measurement, the CP type of CSI-RS resource(s) on neighbor cell (e.g., base station 103) configured for L1-RSRP measurement is the same as the CP type of CSI-RS resource(s) on the serving cell (e.g., base station 101) indicated for L1-RSRP measurement, the L1-RSRP measurement is applied for SCS=60 KHz, and the center frequency of CSI-RS resource(s) on the neighbor cell (e.g., base station 103) configured for L1-RSRP measurement is the same as the center frequency of CSI-RS resource(s) on the serving cell (e.g., base station 101) indicated for L1-RSRP measurement.

Additionally, or alternatively, a measurement can be defined as a CSI-RS based inter-frequency L1-RSRP measurement provided it is not defined as an intra-frequency L1-RSRP measurement as discussed above.

Some aspects of this disclosure are directed to intra-frequency CSI-RS based L1 measurement on the neighbor cell in FR1. According to some aspects, the intra-frequency CSI-RS based L1 measurement can include intra-frequency CSI-RS based L1-SINR measurement or intra-frequency CSI-RS based L1-RSRP measurement on the neighbor cell. In this example, UE 105 can use an intra-frequency CSI-RS based L1 measurement period in FR1 to perform the intra-frequency CSI-RS based L1 measurement(s). During the intra-frequency CSI-RS based L1 measurement period, UE 105 can perform the L1 measurement(s) (L1-SINR measurement and/or L1-RSRP measurement) on the neighbor cell (e.g., base station 103) using one or more CSI-RS resources.

Table 1 below illustrates one exemplary method to determine an intra-frequency CSI-RS based L1-SINR measurement period in FR1. In this example, UE 105 uses the intra-frequency L1-SINR measurement period to perform L1-SINR measurement in FR1 on the neighbor cell (e.g., base station 103) using one or more CSI-RS resources. In some examples, the intra-frequency CSI-RS based L1-SINR measurement period is for intra-frequency CSI-RS based L1-SINR measurement for CMR only and no IMR in FR1.

TABLE 1
Measurement period Tᵢₙₜᵣₐ_{_{—}}_{L1-SINR}_{_{—}}_{Measurement}_{_{—}}_{Period}_{_{—}}_{CSI-RS}_{_{—}}_{CMR Only} for FR1

| Configuration | Tᵢₙₜᵣₐ_{_{—}}_{L1-SINR}_{_{—}}_{Measurement}_{_{—}}_{Period}_{_{—}}_{CSI-RS}_{_{—}}_{CMR}_{_{—}}_{Only} (ms) |
|---|---|
| Non-DRX | max(T_{Report}, ceil(M*P)*T_{CSI-RS-neighbor}) |
| DRX cycle ≤ 320 ms | max(TReport, ceil(1.5 K *M*P)*max(T_{DRX}, T_{CSI-RS-neighbor})) |
| DRX cycle > 320 ms | ceil(M*P)*T_{DRX} |

Table 2 below illustrates one exemplary method to determine an intra-frequency CSI-RS based L1-RSRP measurement period in FR1. In this example, UE 105 uses the intra-frequency L1-RSRP measurement period to perform L1-RSRP measurement in FR1 on the neighbor cell (e.g., base station 103) using one or more CSI-RS resources.

TABLE 2
Measurement period T_{L1-RSRP}_{_{—}}_{Neighbor}_{_{—}}_{Measurement}_{_{—}}_{Period}_{_{—}}_{CSI-RS} for FR1

| Configuration | T_{L1-RSRP}_{_{—}}_{Neighbor}_{_{—}}_{Measurement}_{_{—}}_{Period}_{_{—}}_{CSI-RS} (ms) |
|---|---|
| Non-DRX | max(T_{Report}, ceil(M*P)*T_{CSI-RS-neighbor}) |
| DRX cycle ≤ 320 ms | max(T_{Report}, ceil(1.5 K *M*P)*max(T_{DRX}, T_{CSI-RS-neighbor})) |
| DRX cycle > 320 ms | ceil(M*P)*T_{DRX} |

In these examples, the values of the intra-frequency L1-SINR measurement period and the intra-frequency L1-RSRP measurement period can be determined based on Discontinuous Reception (DRX), where T_{DRX} is the DRX cycle length. In this example, T_{CSI-RS-neighbor} is the periodicity of the CSI-RS configured for L1-SINR measurement (or L1-RSRP measurement) on the neighbor cell (e.g., base station 103). T_{Report} is configured periodicity for reporting.

According to some examples, the value of the intra-frequency L1-SINR measurement period provided in Table 1 and the value of the intra-frequency L1-RSRP measurement period provided in Table 2 are applicable provided that the CSI-RS resource(s) configured for L1-SINR measurement on the neighbor cell is transmitted with density=D. According to some aspects, K−1 when T_{SSB}≤40 ms and Radio Resource Management (RRM) enhancements for high speed are configured. Otherwise K=1.5. In some examples, T_{SSB} can include the length of SSB in time.

According to some aspects, M in Tables 1 and 2 is a measurement sample. For example, the measurement sample can include the number of resources (e.g., CSI-RS and/or SSB resource(s)) used by UE to perform the L1 measurement (e.g., L1-SINR and/or L1-RSRP measurement(s)) on the neighbor cell. In some examples, the value of M in Table 1 is 1 (M=1) for aperiodic CSI-RS resource(s) as CMR. According to some aspects, the value of M in Table 1 is 1 (M=1) for periodic and semi-persistent CSI-RS resource(s) as CMR if higher layer parameter timeRestrictionForChannelMeasurement is configured. If the higher layer parameter timeRestrictionForChannelMeasurement is not configured, then the value of M in Table 1 is 3 (M=3). In the examples where M=3, the UE can use 3 resources to perform the measurements and the UE can use an average of the measurements for the L1 measurement. The aspects of this disclosure are not limited to these examples and other measurement sample numbers can be used.

According to some aspects, D is the density of the CSI-RS resource(s) configured for L1-SINR, measurement or L1-RSRP measurement on the neighbor cell. Different requirements can be defined for different density. In a non-limiting example, the value of D can be 3 (D=3). Other values, such as but not limited to, 1 and 5 can be used for D.

According to some aspects, the value of sharing factor P used in determining the value of Me intra-frequency L1-SINR measurement period in Table 1 or in determining the value of the intra-frequency L1-RSRP measurement period in Table 2 can depend on the measurement gaps of, for example, the serving cell (e.g., base station 101). In some examples, the serving cell (e.g., base station 101) can communicate to the UE (e.g., UE 105) a measurement gap signal. The measurement gap signal informs the UE of time intervals (measurement gaps) that the UE can use to detect and measure other carriers.

According to some aspects, when in the monitored cell (e.g., the serving cell), there are measurement gaps configured for intra-frequency, inter-frequency, or inter-RAT (Radio Access Technology) measurements, which are overlapping with some but not all occasions of the CSI-RS resource(s) configured for L1-SINR measurement or L1-RSRP measurement in the neighbor cell, the value of sharing factor P can be determined as:

$$P = \frac{1}{1 - \frac{{T}_{CSI ‐ RS ‐ neighbor}}{MGRP}} \qquad ( 1 )$$

Here, T_{CSI-RS-neighbor} is the periodicity of CSI-RS resource(s) configured for L1-SINR measurement or L1-RSRP measurement in the neighbor cell. Also, MGRP is the Measurement Gap Repetition Period.

In some aspects, when in the monitored cell (e.g., the serving cell), there are no measurement gaps overlapping with any occasion of the CSI-RS resource(s) configured for L1-SINR measurement or L1-RSRP measurement in neighbor cell, then P=1.

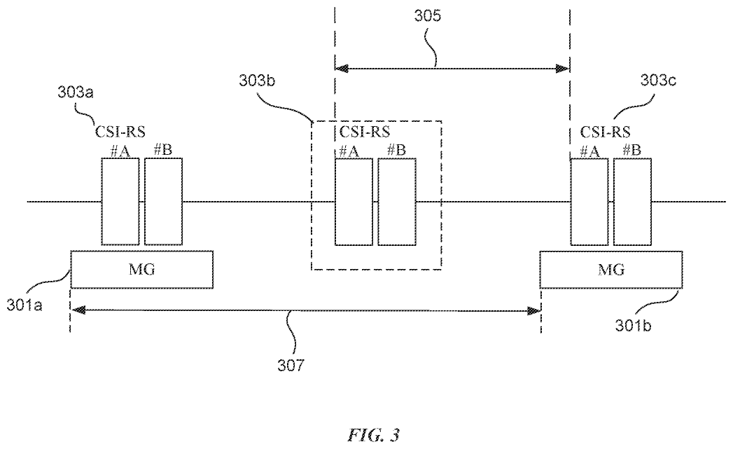

FIG. 3 illustrates an exemplary intra-frequency CSI-RS based L1 measurement (e.g., L1-SINR measurement and/or L1-RSRP measurement) in a neighbor cell in FR1, according to some aspects. As illustrated in FIG. 3, measurement gaps 301a and 301b (herein referred to as measurement gaps 301) are aligned with some, but not all occasions of CSI-RS resources 303a, 303b, and 303c (herein referred to as CSI-RS resources 303). In the example of FIG. 3, measurement gap 301a is aligned with CSI-RS resources 303a and measurement gap 301b is aligned with CSI-RS resources 303c. In this example, CSI-RS resources 303 are configured for neighbor cell L1 measurement (e.g., L1-SINR measurement and/or L1-RSRP measurement) in FR1. In this example, CSI-RS resources 303b is not aligned with any measurement gap. The UE (e.g., UE 105) can use CSI-RS resources 303b to perform neighbor cell L1 measurement (e.g., measurement and/or L1-RSRP measurement) in FR1.

Time interval 305 can indicate the periodicity of CSI-RS resource(s) configured for L1 measurement (e.g., L1-SINR measurement and/or L1-RSRP measurement—T_{CSI-RS-neighbor}) in the neighbor cell. Similarly, time interval 307 can indicate the Measurement Gap Repetition Period (MGRP). In the example illustrated in FIG. 3, sharing factor P is 1/3. In this example, sharing factor P of ⅓ can be used in determining the value of the intra-frequency L1 measurement period in Table 1 and/or Table 2.

Some aspects of this disclosure are directed to intra-frequency SSB based L1-RSRP measurement on the neighbor cell in FR1. In this example, UE 105 can use an intra-frequency SSB based L1-RSRP measurement period in FR1. to perform the intra-frequency SSB based L1-RSRP measurement(s). During the intra-frequency SSB based L1-RSRP measurement period, UE 105 can perform the L1-RSRP measurement(s) on the neighbor cell (e.g., base station 103) using one or more SSB resources in FR1.

Table 3 below illustrates one exemplary method to determine an intra-frequency SSB based L1-RSRP measurement period in FR1.

TABLE 3
Measurement period T_{L1-RSRP}_{_{—}}_{Neighbor}_{_{—}}_{Measurement}_{_{—}}_{Period}_{_{—}}_{SSB} for FR1

| Configuration | T_{L1-RSRP}_{_{—}}_{Neighbor}_{_{—}}_{Measurement}_{_{—}}_{Period}_{_{—}}_{SSB} (ms) |
|---|---|
| Non-DRX | max(T_{Report}, ceil(M*P)*T_{SSB-neighbor}) |
| DRX cycle ≤ 320 ms | max(T_{Report}, ceil(1.5 K *M*P)*max(T_{DRX}, T_{SSB-neighbor})) |
| DRX cycle > 320 ms | ceil(M*P)*T_{DRX} |

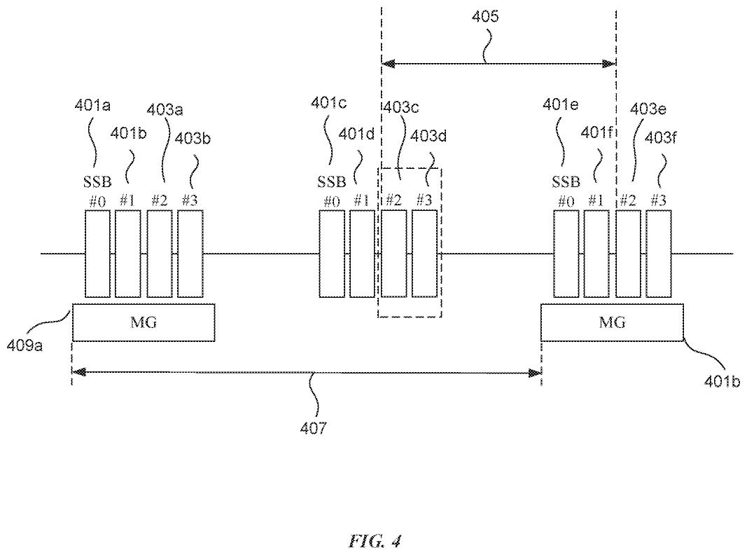

In this example, T_{SSB-neighbor} is the periodicity of the SSB-Index (e.g., SSB resource(s)) configured for L1-RSRP measurement on the neighbor cell (e.g., base station 103). According to some aspects, K, T_{Report}, and measurement sample (M) are defined as discussed above. The value of sharing factor P in Table 3 can be determined as discussed below in more detail (for example, with respect to FIG. 4).

According to some aspects, if in the monitored cell (e.g., the serving cell) there are measurement gaps configured for intra-frequency, inter-frequency, or inter-RAT measurements, which are overlapping with some but not all occasions of the SSB resource(s) configured for L1-RSRP measurement in the neighbor cell (e.g., base station 103), then the value of sharing factor P can be determined as follows:

$$P = \frac{1}{1 - \frac{{T}_{SSB ‐ neighbor}}{MGRP}} \qquad ( 2 )$$

However, if in the monitored cell (e.g., the serving cell) there are no measurement gaps overlapping with any occasion of the SSB resource(s) configured for L1-RSRP measurement in neighbor cell, the P=1.

FIG. 4 illustrates an exemplary intra-frequency SSB based L1-RSRP measurement in FR1, according to some aspects. In this example, SSB resources 401a-f (e.g., SSB resources #0 and 1) are configured for Layer 3 (L3) measurement. SSB resources 403a-f (e.g., SSB resources # 2 and 3) are configured L1 measurement on both the serving cell and the neighbor cell.

Measurement gaps 409a and 409b are aligned with some, but not all occasions of SSB resources. For example, measurement gap 409a is aligned with SSB resources 403a and 403b, and measurement gap 409b is aligned with SSB resources 403e and 403f. However, SSB resources 403c and 403d are not aligned with any measurement gap. In this example, the UE can use SSB resources 403c and 403d to perform neighbor cell L1 measurement (e.g., L1-RSRP measurement) in FR1. Time interval 405 can indicate the periodicity of SSB resource(s) configured for L1-RSRP measurement in FR1 (e.g., T_{SSB-neighbor}) in the neighbor cell. Similarly, time interval 407 can indicate the MGRP.

In the example illustrated in FIG. 4, sharing factor P is 1/3. In this example, sharing factor P of ⅓ can be used in determining the value of the intra-frequency L1-RSRP measurement period in Table 3.

Some aspects of this disclosure are directed to intra-frequency CSI-RS based L1 measurement on the neighbor cell in FR2. In some aspects, the intra-frequency CSI-RS based L1 measurement can include intra-frequency CSI-RS based L1-SINR measurement or intra-frequency CSI-RS based L1-RSRP measurement on the neighbor cell in FR2. In this example, UE 105 can use an intra-frequency CSI-RS based L1 measurement period in FR2 to perform the intra-frequency CSI-RS based L1 measurement(s). During the intra-frequency CSI-RS based L1 measurement period, UE 105 can perform the L1 measurement(s) (L1-SINR measurement and/or L1-RSRP measurement) on the neighbor cell (e.g., base station 103) using one or more CSI-RS resources.

Table 4 below illustrates one exemplary method to determine an intra-frequency CSI-RS based L1-SINR measurement period in FR2. In this example, UE 105 uses the intra-frequency L1-SINR measurement period to perform L1-SINR measurement in FR2on the neighbor cell (e.g., base station 103) using one or more CSI-RS resources. In some examples, the intra-frequency CSI-RS based L1-SINR measurement period is for intra-frequency CSI-RS based L1-SINR measurement for CMR only and no IMR in FR2.

TABLE 4
Measurement period Tᵢₙₜᵣₐ_{_{—}}_{L1-SINR}_{_{—}}_{Measurement}_{_{—}}_{Period}_{_{—}}_{CSI-RS}_{_{—}}_{CMR}_{_{—}}_{Only} for FR2

| Configuration | Tᵢₙₜᵣₐ_{_{—}}_{L1-SINR}_{_{—}}_{Measurement}_{_{—}}_{Period}_{_{—}}_{CSI-RS}_{_{—}}_{CMR}_{_{—}}_{Only} (ms) |
|---|---|
| Non-DRX | max(T_{Report}, ceil(M*P*N)*T_{CSI-RS-neighbor}) |
| DRX cycle ≤ 320 ms | max(T_{Report}, ceil(1.5 K *M*P*N)*max(T_{DRX}, T_{CSI-RS-neighbor})) |
| DRX cycle > 320 ms | ceil(M*P*N)*T_{DRX} |

Table 5 below illustrates one exemplary method to determine an intra-frequency CSI-RS based L1-RSRP measurement period in FR2. In this example, UE 105 uses the intra-frequency L1-RSRP measurement period to perform L1-RSRP measurement in FR2 on the neighbor cell (e.g., base station 103) using one or more CSI-RS resources.

TABLE 5
Measurement period T_{L1-RSRP}_{_{—}}_{Neighbor}_{_{—}}_{Measurement}_{_{—}}_{Period}_{_{—}}_{CSI-RS} for FR2

| Configuration | T_{L1-RSRP}_{_{—}}_{Neighbor}_{_{—}}_{Measurement}_{_{—}}_{Period}_{_{—}}_{CSI-RS} (ms) |
|---|---|
| Non-DRX | max(T_{Report}, ceil(M*P*N)*T_{CSI-RS-neighbor}) |
| DRX cycle ≤ 320 ms | max(T_{Report}, ceil(1.5 K *M*P*N)*max(T_{DRX}, T_{CSI-RS-neighbor})) |
| DRX cycle > 320 ms | ceil(M*P*N)*T_{DRX} |

According to some examples, the values of the intra-frequency L1 measurement period (e.g., L1-SINR measurement period or L1-RSRP measurement period) provided in Tables 4 and 5 are applicable provided that the CSI-RS resource(s) configured for L1 measurement on the neighbor cell is transmitted with density=D.

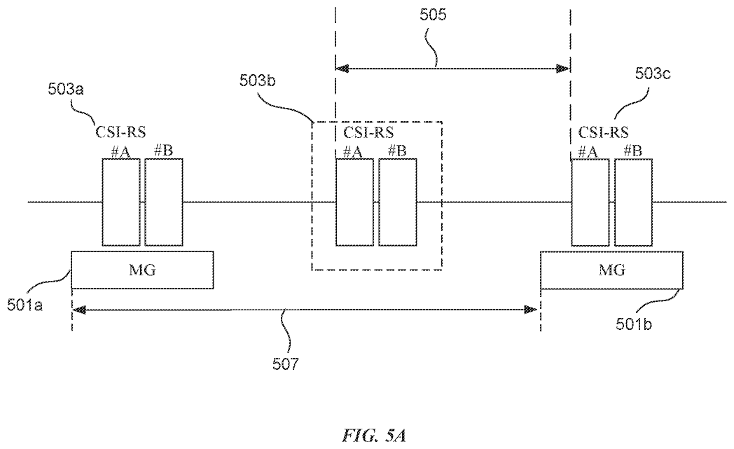

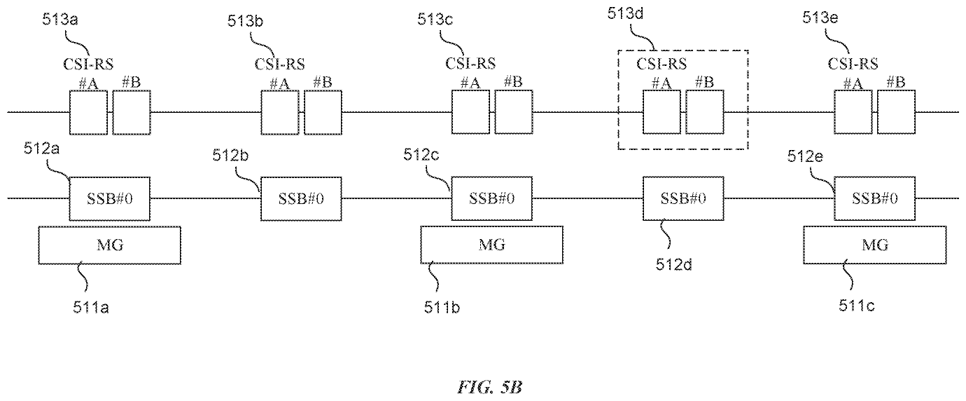

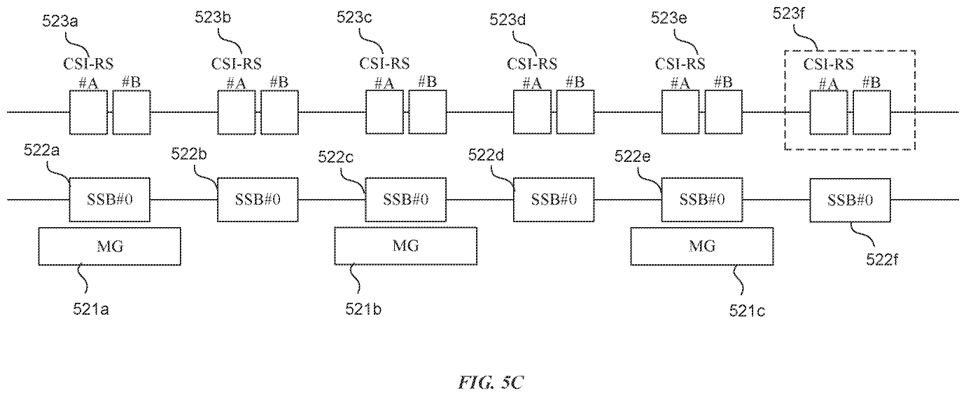

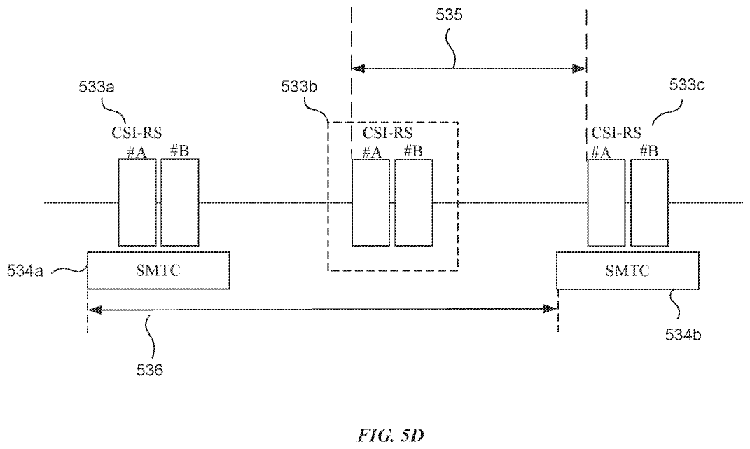

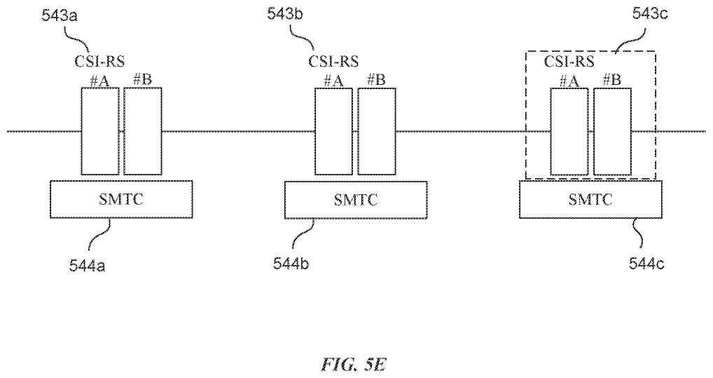

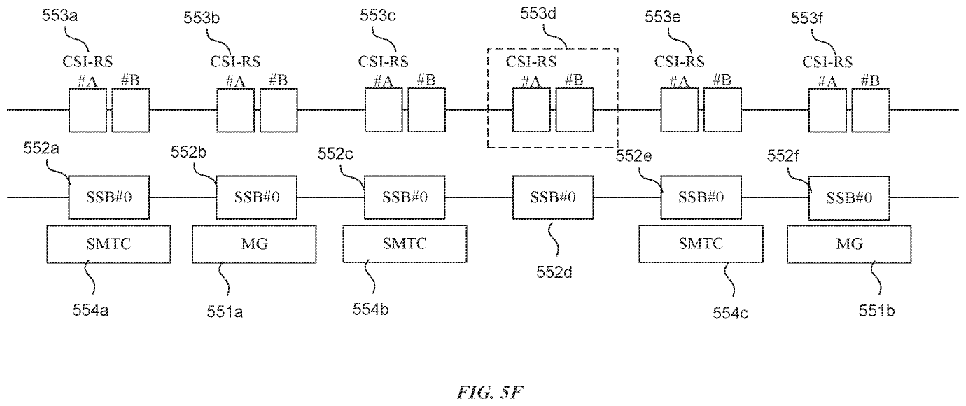

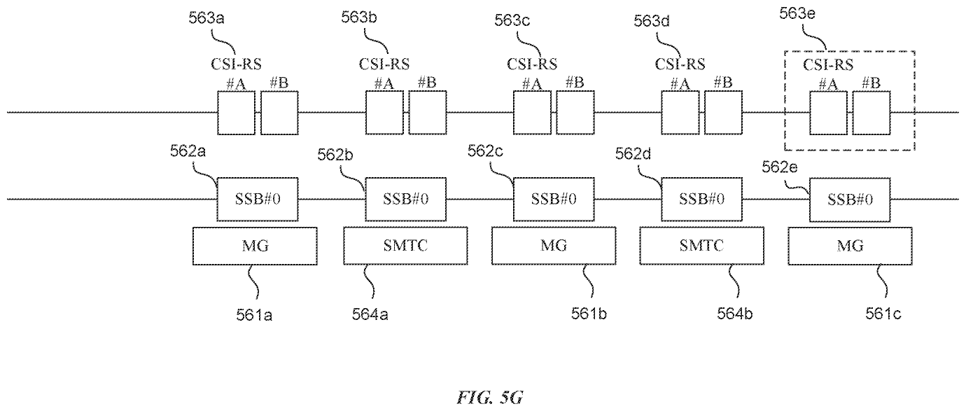

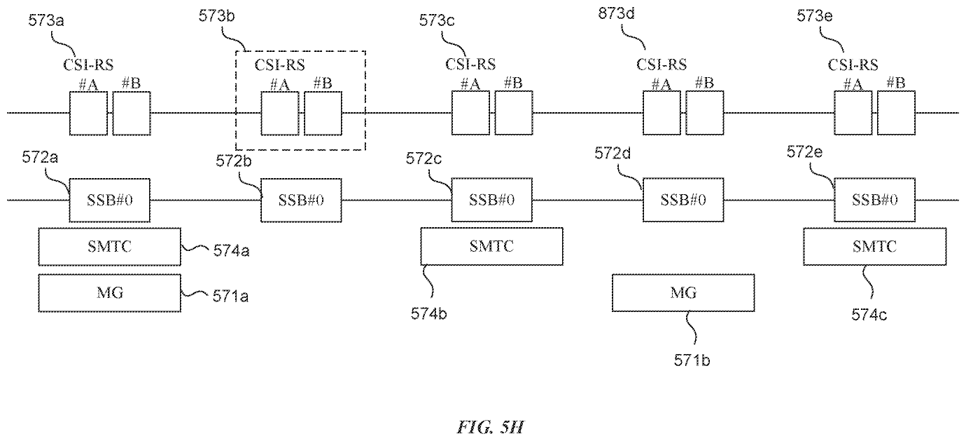

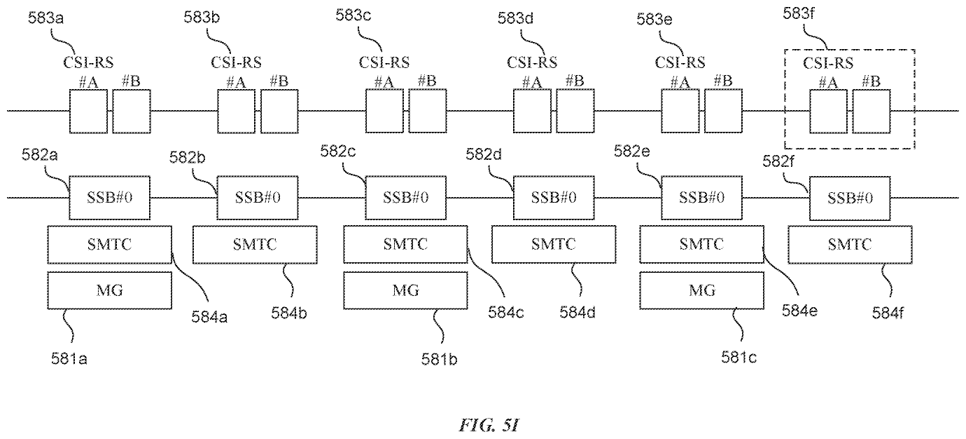

In some examples, the values of M and N in Tables 4 and 5 are determined by network configuration. As a non-limiting example, the value of M and N can be defined by TS38.133 clause 9.8.4.1 or 9.5.4.2. According to some aspects, K and D are defined as discussed above. The value of P in Tables 4 and 5 can be determined based on different criteria as discussed below in more detail (for example, with respect to FIGS. 5A-5I).

According to some aspects, the value of sharing factor P in Tables 4 and 5 can be determined based on whether the CSI-RS resource(s) overlap (and if they do, how much) with measurement gap(s) and whether the CSI-RS resource(s) overlap (and if they do, how much) with Synchronization Signal Block (SSB) based Measurement Timing Configuration (SMTC) occasion(s). In some examples, the SMTC occasion(s) can be associated with one or more carriers.

In some aspects, the CSI-RS resource(s) from the neighbor cell does not overlap with a measurement gap and the CSI-RS resource(s) from the neighbor cell does not overlap with a SMTC occasion. In these examples, if the CSI-RS resource(s) from the neighbor cell does not overlap with SSB/CSI-RS resource(s) for the serving cell's L1-RSRP/SINR/BFD/CBD/RLM, then the value of sharing factor P in Tables 4 and 5 is 1 (P=1). In some examples, BFD is Beam Failure Detection, CBD is Candidate Beam Detection, and RLM is Radio Link Monitoring.

If the CSI-RS resource(s) from the neighbor cell overlaps with the SSB/CSI-RS resources for the serving cell's L1-RSRP/SINR/BFD/CBD/RLM, then the value of sharing factor P in Tables 4 and 5 can be determined using different methods. In one option, the value of sharing factor P in Tables 4 and 5 can be 2 (P=2). In this example, the measurement opportunity is divided (e.g., equally split) between the serving cell and the neighbor cell. In another option, the value of sharing factor P in Tables 4 and 5 can be 3 (P=3). In this example, the serving cell measurement is prioritized compared to the neighbor cell (e.g., ⅔ for the serving cell and ⅓ for the neighbor cell.) In another option, no requirement is defined for this case and the UE's behavior can be unspecified. Although three options (and two values of P) are provided in this example, the aspects of this disclosure are not limited to these examples and other values of P can be defined for prioritizing the serving cell measurements and the neighbor cell measurements.

In some aspects, the CSI-RS resource(s) from the neighbor cell partially overlaps with a measurement gap and the CSI-RS resource(s) from the neighbor cell does not overlap with a SMTC occasion (e.g., T_{CSI-RS-neighbor}<MGRP). In these examples, if the CSI-RS resource(s) from the neighbor cell does not overlap with SSB/CSI-RS resource(s) for the serving cell's L1-RSRP/SINR/BFD/CBD/RLM, then the value of sharing factor P in Tables 4 and 5 is determined as follows:

$$P = \frac{1}{1 - \frac{{T}_{CSI ‐ RS ‐ neighbor}}{MGRP}} \qquad ( 3 )$$

FIG. 5A illustrates one exemplary intra-frequency CSI-RS based L1 measurement in FR2, according to some aspects. In this example, the CSI-RS resource(s) from the neighbor cell partially overlaps with a measurement gap and the CSI-RS resource(s) from the neighbor cell does not overlap with a SMTC occasion. In this example, the CSI-RS resource(s) from the neighbor cell does not overlap with SSB/CSI-RS resource(s) for the serving cell's L1-RSRP/SINR/BFD/CBD/RLM.

In this example, the partial overlap between the CSI-RS resources and the measurement gap is illustrated in FIG. 5A as measurement gap 501a overlapping with CSI-RS resources 503a, measurement gap 501b overlapping with CSI-RS resources 503c, and CSI-RS resources 503b not overlapping any measurement gap. In this example, CSI-RS resources 503 are configured for neighbor cell L1 measurement (e.g., L1-SINR measurement and/or L1-RSRP measurement) in FR2. In this example, CSI-RS resources 503b do not overlap any measurement gap. The UE (e.g., UE 105) can use CSI-RS resources 503b to perform neighbor cell L1 measurement (e.g., L1-SINR measurement and/or L1-RSRP measurement) in FR2. Time interval 505 can indicate the periodicity of CSI-RS resource(s) configured for L1 measurement in FR2 (e.g., L1-SINR measurement and/or L1-RSRP measurement in—T_{CSI-RS-neighbor}) in the neighbor cell. Similarly, time interval 507 can indicate the MGRP.

In some aspects that the CSI-RS resource(s) from the neighbor cell partially overlaps with a measurement gap and the CSI-RS resource(s) from the neighbor cell does not overlap with a SMTC occasion (e.g., T_{CSI-RS-neighbor}<MGRP), if the CSI-RS resource(s) from the neighbor cell does overlaps with SSB/CSI-RS resource(s) for the serving cell's L1-RSRP/SINR/BFD/CBD/RLM, then one option is to divided (e.g., equally split) the measurement opportunity between the serving cell and the neighbor cell. In this example, the value of sharing factor P in Tables 4 and 5 is determined as follows:

$$P = \frac{2}{1 - \frac{{T}_{CSI ‐ RS ‐ neighbor}}{MGRP}} \qquad ( 4 )$$

FIG. 5B illustrates another exemplary intra-frequency CSI-RS based L1 measurement in FR2, according to some aspects. In this example, the CSI-RS resource(s) from the neighbor cell partially overlaps with a measurement gap and the CSI-RS resource(s) from the neighbor cell does not overlap with a SMTC occasion. In this example, the CSI-RS resource(s) from the neighbor cell does overlaps with SSB/CSI-RS resource(s) for the serving cell's L1-RSRP/SINR/BFD/CBD/RLM. As illustrated in FIG. 5B, measurement gap 511a and serving cell's L1-RSRP/SINR/BFD/CBD/RLM 512a overlap with CSI-RS resources 513a. Measurement gap 511b and serving cell's L1-RSRP/SINR/BFD/CBD/RLM 512c overlap with CSI-RS resources 513c. Measurement gap 511c and serving cell's L1-RSRP/SINR/BFD/CBD/RLM 512e overlap with CSI-RS resources 513e. In this example, CSI-RS resources 513 are configured for neighbor cell L1 measurement (e.g., L1-SINR measurement and/or L1-RSRP measurement) in FR2. In this example, serving cell's L1-RSRP/SINR/BFD/CBD/RLM 512 are configured for serving cell L1 measurement.

In this example, serving cell's L1-RSRP/SINR/BFD/CBD/RLM 512b overlaps with CSI-RS resources 513b but CSI-RS resources 513b does not overlap any measurement gap. And, serving cell's L1-RSRP/SINR/BFD/CBD/RLM 512d overlaps with CSI-RS resources 513d but CSI-RS resources 513b does not overlap any measurement gap. In this example, the partial overlap between the CSI-RS resources and the measurement gap is illustrated in FIG. 5B as measurement gaps 511a, b, c overlapping CSI-RS resources 513a, c, and e, respectively, but CSI-RS resources 513b and e not overlapping any measurement gap. The UE can use CSI-RS resources 513d to perform neighbor cell L1 measurement (e.g., L1-SINR measurement and/or L1-RSRP measurement) in FR2. The UE can use CSI-RS resources 513b to perform serving cell L1 measurement. In this example, the measurement opportunity is divided (e.g., equally split) between the serving cell and the neighbor cell.

In some aspects that the CSI-RS resource(s) from the neighbor cell partially overlaps with a measurement gap and the CSI-RS resource(s) from the neighbor cell does not overlap with a SMTC occasion (e.g., T_{CSI-RS-neighbor}<MGRP), if the CSI-RS resource(s) from the neighbor cell does overlaps with SSB/CSI-RS resource(s) for the serving cell's L1-RSRP/SINR/BFD/CBD/RLM, then another option is to prioritize the serving cell measurement. In a non-limiting example, the value of sharing factor P in Tables 4 and 5 is determined as follows:

$$P = \frac{3}{1 - \frac{{T}_{CSI ‐ RS ‐ neighbor}}{MGRP}} \qquad ( 5 )$$

In this example, ⅔ of the measurement opportunity is for the serving cell and ⅓ of the measurement opportunity is for the neighbor cell. It is noted the prioritization of the serving cell measurement can include other ratios of the measurement opportunity between the serving cell and the neighbor cell. Also, in some aspects, the neighbor cell measurement can be prioritized.

FIG. 5C illustrates another exemplary intra-frequency CSI-RS based L1 measurement in FR2, according to some aspects. In this example, the CSI-RS resource(s) from the neighbor cell partially overlaps with a measurement gap and the CSI-RS resource(s) from the neighbor cell does not overlap with a SMTC occasion. In this example, the CSI-RS resource(s) from the neighbor cell does overlaps with SSB/CSI-RS resource(s) for the serving cell's L1-RSRP/SINR/BFD/CBD/RLM. As illustrated in FIG. 5C, measurement gap 521a and serving cell's L1-RSRP/SINR/BFD/CBD/RLM 522a overlap with CSI-RS resources 523a. Measurement gap 521b and serving cell's L1-RSRP/SINR/BFD/CBD/RLM 522c overlap with CSI-RS resources 523c. Measurement gap 521c and serving cell's L1-RSRP/SINR/BFD/CBD/RLM 522e overlap with CSI-RS resources 523e. In this example, CSI-RS resources 523 are configured for neighbor cell L1 measurement (e.g., L1-SINR measurement and/or L1-RSRP measurement) in FR2. In this example, serving cell's L1-RSRP/SINR/BFD/CBD/RLM 522 are configured for serving cell L1 measurement.

In this example, serving cell's L1-RSRP/SINR/BFD/CBD/RLM 522b overlaps with CSI-RS resources 523b but CSI-RS resources 523b does not overlap any measurement gap. And, serving cell's L1-RSRP/SINR/BFD/CBD/RLM 522d overlaps with CSI-RS resources 523d but CSI-RS resources 523d does not overlap any measurement gap. And, serving cell's L1-RSRP/SINR/BFD/CBD/RLM 522f overlaps with CSI-RS resources 523f but CSI-RS resources 523f does not overlap any measurement gap. In this example, the partial overlap between the CSI-RS resources and the measurement gap is illustrated in FIG. 5C as measurement gaps 521a, b, c overlapping CSI-RS resources 523a, c, and e, respectively, but CSI-RS resources 523b and e not overlapping any measurement gap.

The UE (e.g., UE 105) can use CSI-RS resources 523f to perform neighbor cell L1 measurement (e.g., L1-SINR measurement and/or L1-RSRP measurement) in FR2. The UE (e.g., UE 105) can use CSI-RS resources 523b and 523d to perform serving cell L1 measurement. In this example, the measurement opportunity is split between the serving cell and the neighbor cell in a ⅔ and ⅓ ratios.

In some aspects that the CSI-RS resource(s) from the neighbor cell partially overlaps with a measurement gap and the CSI-RS resource(s) from the neighbor cell does not overlap with a SMTC occasion (e.g., T_{CSI-RS-neighbor}<MGRP), if the CSI-RS resource(s) from the neighbor cell does overlaps with SSB/CSI-RS resource(s) for the serving cell's L1-RSRP/SINR/BFD/CBD/RLM, then another option is to not define any requirement for this case. In this case, the behavior of the UE can be unspecified.

In some aspects, the CSI-RS resource(s) from the neighbor cell does not overlap with a measurement gap and the CSI-RS resource(s) from the neighbor cell partially overlaps with a SMTC occasion (e.g., T_{CSI-RS-neighbor}<T_{SMTCperiod}). In these examples, if the CSI-RS resource(s) from the neighbor cell does not overlap with SSB/CSI-RS resource(s) for the serving cell's L1-RSRP/SINR/BFD/CBD/RLM, then the value of sharing factor P in Tables 4 and 5 is determined as follows:

$$P = \frac{1}{1 - \frac{{T}_{CSI - RS - neighbor}}{{T}_{SMTCperiod}}} \qquad ( 6 )$$

FIG. 5D illustrates another exemplary intra-frequency CSI-RS based L1 measurement in FR2, according to some aspects. In this example, the CSI-RS resource(s) from the neighbor cell does not overlap with a measurement gap and the CSI-RS resource(s) from the neighbor cell partially overlaps with a SMTC occasion. In this example, the CSI-RS resource(s) from the neighbor cell does not overlap with SSB/CSI-RS resource(s) for the serving cell's L1-RSRP/SINR/BFD/CBD/RLM. As illustrated in FIG. 5D, SMTC 534a overlaps with CSI-RS resources 533a and SMTC 534b overlaps with CSI-RS resources 533b. In this example, CSI-RS resources 533 are configured for neighbor cell L1 measurement (e.g., L1-SINR measurement and/or L1-RSRP measurement) in FR2. In this example, CSI-RS resources 533b do not overlap any SMTC. The UE (e.g., UE 105) can use CSI-RS resources 533b to perform neighbor cell L1 measurement (e.g., L1-SINR measurement and/or L1-RSRP measurement) in FR2.

In this example, the partial overlap between the CSI-RS resources and the SMTC is illustrated in FIG. 5D as SMTC 534a and 534b overlapping CSI-RS resources 533a and 533c, respectively, but CSI-RS resources 533b not overlapping any SMTC.

As illustrated in FIG. 5D, time interval 535 can indicate the periodicity of CSI-RS resource(s) configured for L1 measurement in FR2 (e.g., L1-SINR measurement and/or L1-RSRP measurement in—T_{CSI-RS-neighbor}) in the neighbor cell. Similarly, time interval 536 can indicate the SMTC period (e.g., T_{SMTCperiod}).

In some aspects that the CSI-RS resource(s) from the neighbor cell does not overlap with a measurement gap and the CSI-RS resource(s) from the neighbor cell partially overlaps with a SMTC occasion (e.g., T_{CSI-RS-neighbor}<T_{SMTCperiod}), if the CSI-RS resource(s) from the neighbor cell overlaps with SSB/CSI-RS resource(s) for the serving cell's L1-RSRP/SINR/BFD/CBD/RLM, then one or more options can be used for determining the value of sharing factor P in Tables 4 and 5.

In one example, the value of sharing factor P is determined such that the measurement opportunity is divided (e.g., equally split) between the serving cell and the neighbor cell. In this example, the value of P in Tables 4 and 5 is determined as follows:

$$P = \frac{2}{1 - \frac{{T}_{CSI - RS - neighbor}}{{T}_{SMTCperiod}}} \qquad ( 7 )$$

In another example, the value of sharing factor P is determined such that the serving cell measurement is prioritized. For example, ⅔ of the measurement opportunity is for the serving cell and ⅓ of the measurement opportunity is for the neighbor cell. In this example, the value of P in Tables 4 and 5 is determined as follows:

$$P = \frac{3}{1 - \frac{{T}_{CSI - RS - neighbor}}{{T}_{SMTCperiod}}} \qquad ( 8 )$$

It is noted the prioritization of the serving cell measurement can include other ratios of the measurement opportunity between the serving cell and the neighbor cell. Also, in some aspects, the neighbor cell measurement can be prioritized. In another example, no requirement is defined and the behavior of the UE can be unspecified.

In some aspects, the CSI-RS resource(s) from the neighbor cell does not overlap with a measurement gap and the CSI-RS resource(s) from the neighbor cell fully overlaps with a SMTC occasion (e.g., T_{CSI-RS-neighbor}=T_{SMTCperiod}). In these examples, if the CSI-RS resource(s) from the neighbor cell does not overlap with SSB/CSI-RS resource(s) for the serving cell's L1-RSRP/SINR/BFD/CBD/RLM, then the value of sharing factor P in Tables 4 and 5 is determined as follows:

P=P_{sharing factor} (9)

FIG. 5E illustrates another exemplary intra-frequency CSI-RS based L1 measurement in FR2, according to some aspects. In this example, the CSI-RS resource(s) from the neighbor cell does not overlap with a measurement gap and the CSI-RS resource(s) from the neighbor cell fully overlaps with a SMTC occasion. In this example, the CSI-RS resource(s) from the neighbor cell does not overlap with SSB/CSI-RS resource(s) for the serving cell's L1-RSRP/SINR/BFD/CBD/RLM. As illustrated in FIG. 5E, SMTC 544a overlaps with CSI-RS resources 543a, SMTC 544b overlaps with CSI-RS resources 543b, and SMTC 544c overlaps with CSI-RS resources 543c. In this example, CSI-RS resources 543 are configured for neighbor cell L1 measurement (e.g., L1-SINR measurement and/or L1-RSRP measurement) in FR2. In this example, the UE (e.g., UE 105) can use CSI-RS resources 543c to perform neighbor cell L1 measurement (e.g., L1-SINR measurement and/or L1-RSRP measurement) in FR2. In this example, the full overlap between the CSI-RS resources and the SMTC is illustrated in FIG. 5E as SMTC 544a-c overlapping with CSI-RS resources 543a-c, respectively.

In some aspects that the CSI-RS resource(s) from the neighbor cell does not overlap with a measurement gap and the CSI-RS resource(s) from the neighbor cell fully overlaps with a SMTC occasion (e.g., T_{CSI-RS-neighbor}=T_{SMTCperiod}), if the CSI-RS resource(s) from the neighbor cell overlaps with SSB/CSI-RS resource(s) for the serving cell's L1-RSRP/SINR/BFD/CBD/RLM, then one or more options can be used for determining the value of sharing factor P in Tables 4 and 5.

In one example, the value of sharing factor P is determined such that the measurement opportunity is divided (e.g., equally split) between the serving cell and the neighbor cell. In this example, the value of P in Tables 4 and 5 is determined as follows:

P=2*P_{sharing factor} (10)

In another example, the value of P is determined such that the serving cell measurement is prioritized. For example, ⅔ of the measurement opportunity is for the serving cell and ⅓ of the measurement opportunity is for the neighbor cell. In this example, the value of sharing factor P in Tables 4 and 5 is determined as follows:

P=3*P_{sharing factor} (11)

It is noted the prioritization of the serving cell measurement can include other ratios of the measurement opportunity between the serving cell and the neighbor cell. Also, in some aspects, the neighbor cell measurement can be prioritized. In another example, no requirement is defined and the behavior of the UE can be unspecified.

In some aspects, the CSI-RS resource(s) from the neighbor cell partially overlaps with a measurement gap, the CSI-RS resource(s) from the neighbor cell partially overlaps with a SMTC occasion (e.g., T_{CSI-RS-neighbor}<T_{SMTCperiod}), the SMTC occasion does not overlap with the measurement gap, and (T_{SMTCperiod}≠MGRP or (T_{SMTCperiod}=MGRP and T_{CSI-RS-neighbor}<0.5*T_{SMTCperiod})). In these examples, if the CSI-RS resource(s) from the neighbor cell does not overlap with SSB/CSI-RS resource(s) for the serving cell's L1-RSRP/SINR/BFD/CBD/RLM, then the value of sharing factor P in Tables 4 and 5 is determined as follows:

$$P = \frac{1}{1 - \frac{{T}_{CSI - RS - neighbor}}{MGRP} - \frac{{T}_{CSI - RS - neighbor}}{{T}_{SMTCperiod}}} \qquad ( 12 )$$

FIG. 5F illustrates another exemplary intra-frequency CSI-RS based L1 measurement in FR2, according to some aspects. In this example, the CSI-RS resource(s) from the neighbor cell partially overlaps with a measurement gap, the CSI-RS resource(s) from the neighbor cell partially overlaps with a SMTC occasion (e.g., T_{CSI-RS-neighbor}<T_{SMTCperiod}), the SMTC occasion does not overlap with the measurement gap, and (T_{SMTCperiod}≠MGRP Or (T_{SMTCperiod}=MGRP and T_{CSI-RS-neighbor}<0.5*T_{SMTCperiod})). In this example, the CSI-RS resource(s) from the neighbor cell does not overlap with SSB/CSI-RS resource(s) for the serving cell's L1-RSRP/SINR/BFD/CBD/RLM.

As illustrated in FIG. 5F, SMTC 554a overlaps with serving cell's L1-RSRP/SINR/BFD/CBD/RLM 552a and CSI-RS resources 553a Measurement gap 551a overlaps with serving cell's L1-RSRP/SINR/BFD/CBD/RLM 552b and CSI-RS resources 553b. SMTC 554b overlaps with serving cell's L1-RSRP/SINR/BFD/CBD/RLM 552c and CSI-RS resources 553c. SMTC 554c overlaps with serving cell's L1-RSRP/SINR/BFD/CBD/RLM 552e and CSI-RS resources 553e. Measurement gap 551b overlaps with serving cell's L1-RSRP/SINR/BFD/CBD/RLM 552f and CSI-RS resources 553f. In this example, no SMTC and measurement gap overlaps with serving cell's L1-RSRP/SINR/BFD/CBD/RLM 552e and CSI-RS resources 553e.

In this example, CSI-RS resources 553 are configured for neighbor cell L1 measurement (e.g., L1-SINR measurement and/or L1-RSRP measurement) in FR2. In this example, serving cell's L1-RSRP/SINR/BFD/CBD/RLM 552 are configured for neighbor cell L1 measurement (e.g., L1-RSRP/SINR/BFD/CBD/RLM). The UE (e.g., UE 1.05) can use CSI-RS resources 553d to perform neighbor cell L1 measurement (e.g., L1-SINR measurement and/or L1-RSRP measurement) in FR2.

In this example, the partial overlap between the CSI-RS resources and the SMTC is illustrated in FIG. 5F as SMTC 554a-c overlapping with CSI-RS resources 553a, c, and e, respectively, but CSI-RS resources 553b, d, and f not overlapping any SMTC. Also, in this example, the partial overlap between the CSI-RS resources and the measurement gap is illustrated in FIG. 5F as measurement gap 551a and 551b overlapping with CSI-RS resources 553b and 553f, respectively, but CSI-RS resources 553a, and 553c-e not overlapping any measurement gap.

In some aspects that the CSI-RS resource(s) from the neighbor cell partially overlaps with a measurement gap, the CSI-RS resource(s) from the neighbor cell partially overlaps with a SMTC occasion (e.g., T_{CSI-RS-neighbor}<T_{SMTCperiod}), the SMTC occasion does not overlap with the measurement gap, and (T_{SMTCperiod}≠MGRP or (T_{SMTCperiod}=MGRP and T_{CSI-RS-neighbor}<0.5*T_{SMTCperiod})), if the CSI-RS resource(s) from the neighbor cell overlaps with SSB/CSI-RS resource(s) for the serving cell's L1-RSRP/SINR/BFD/CBD/RLM, then one or more options can be used for determining the value of sharing factor P in Tables 3 and 4.

In one example, the value of sharing factor P is determined such that the measurement opportunity is divided (e.g., equally split) between the serving cell and the neighbor cell. In this example, the value of P in Tables 4 and 5 is determined as follows:

$$P = \frac{2}{1 - \frac{{T}_{CSI - RS - neighbor}}{MGRP} - \frac{{T}_{CSI - RS - neighbor}}{{T}_{SMTCperiod}}} \qquad ( 13 )$$

In another example, the value of sharing factor P is determined such that the serving cell measurement is prioritized. For example, ⅔ of the measurement opportunity is for the serving cell and ⅓ of the measurement opportunity is for the neighbor cell. In this example, the value of P in Tables 4 and 5 is determined as follows:

$$P = \frac{3}{1 - \frac{{T}_{CSI - RS - neighbor}}{MGRP} - \frac{{T}_{CSI - RS - neighbor}}{{T}_{SMTCperiod}}} \qquad ( 14 )$$

It is noted the prioritization of the serving cell measurement can include other ratios of the measurement opportunity between the serving cell and the neighbor cell. Also, in some aspects, the neighbor cell measurement can be prioritized. In another example, no requirement is defined and the behavior of the UE can be unspecified.

In some aspects, the CSI-RS resource(s) from the neighbor cell partially overlaps with a measurement gap, the CSI-RS resource(s) from the neighbor cell partially overlaps with a SMTC occasion (e.g., T_{CSI-RS-neighbor}<T_{SMTCperiod}), the SMTC occasion does not overlap with the measurement gap, T_{SMTCperiod}=MGRP, and T_{CSI-RS-neighbor}=0.5*T_{SMTCperiod}. In these examples, if the CSI-RS resource(s) from the neighbor cell does not overlap with SSB/CSI-RS resource(s) for the serving cell's L1-RSRP/SINR/BFD/CBD/RLM, then the value of sharing factor P in Tables 4 and 5 is determined as follows:

$$P = \frac{3}{1 - \frac{{T}_{CSI - RS - neighbor}}{MGRP}} \qquad ( 15 )$$

FIG. 5G illustrates another exemplary intra-frequency CSI-RS based L1 measurement in FR2, according to some aspects. In this example, the CSI-RS resource(s) from the neighbor cell partially overlaps with a measurement gap, the CSI-RS resource(s) from the neighbor cell partially overlaps with a SMTC occasion (e.g., T_{CSI-RS-neighbor}<T_{SMTCperiod}), the SMTC occasion does not overlap with the measurement gap, T_{SMTCperiod}=MGRP, and T_{CSI-RS-neighbor}=0.5*T_{SMTCperiod}. In this example, the CSI-RS resource(s) from the neighbor cell does not overlap with SSB/CSI-RS resource(s) for the serving cell's L1-RSRP/SINR/BFD/CBD/RLM.

As illustrated in FIG. 5G, measurement gap 561a overlaps with serving cell's L1-RSRP/SINR/BFD/CBD/RLM 562a and CSI-RS resources 563a. SMTC 564a overlaps with serving cell's L1-RSRP/SINR/BFD/CBD/RLM 562b and CSI-RS resources 563b. Measurement gap 561b overlaps with serving cell's L1-RSRP/SINR/BFD/CBD/RLM 562c and CSI-RS resources 563c. SMTC 564b overlaps with serving cell's L1-RSRP/SINR/BFD/CBD/RLM 562d and CSI-RS resources 563d. Measurement gap 561c overlaps with serving cell's L1-RSRP/SINR/BFD/CBD/RLM 562e and CSI-RS resources 563e.

In this example, CSI-RS resources 563 are configured for neighbor cell L1 measurement (e.g., L1-SINR measurement and/or L1-RSRP measurement) in FR2. In this example, serving cell's L1-RSRP/SINR/BFD/CBD/RLM 562 are configured for neighbor cell L1 measurement (e.g., L1-RSRP/SINR/BFD/CBD/RLM). The UE (e.g., UE 105) can use CSI-RS resources 563e to perform neighbor cell L1 measurement (e.g., L1-SINR measurement and/or L1-RSRP measurement) in FR2.

In this example, the partial overlap between the CSI-RS resources and the SMTC is illustrated in FIG. 5G as SMTC 564a and 564b overlapping with CSI-RS resources 563b and 563d, respectively, but CSI-RS resources 563a, c, and e not overlapping any SMTC. Also, in this example, the partial overlap between the CSI-RS resources and the measurement gap is illustrated in FIG. 5G as measurement gap 561a-c overlapping with CSI-RS resources 563a, c, and e, respectively, but CSI-RS resources 563b and 563d not overlapping any measurement gap.

In some aspects that the CSI-RS resource(s) from the neighbor cell partially overlaps with a measurement gap, the CSI-RS resource(s) from the neighbor cell partially overlaps with a SMTC occasion (e.g., T_{CSI-RS-neighbor}<T_{SMTCperiod}), the SMTC occasion does not overlap with the measurement gap, T_{SMTCperiod}=MGRP, and T_{CSI-RS-neighbor}=0.5*T_{SMTCperiod}, if the CSI-RS resource(s) from the neighbor cell overlaps with SSB/CSI-RS resource(s) for the serving cell's L1-RSRP/SINR/BFD/CBD/RLM, then one or more options can be used for determining the value of sharing factor P in Tables 4 and 5.

In one example, the value of sharing factor P is determined such that the measurement opportunity is divided (e.g., equally split) between the serving cell and the neighbor cell. In this example, the value of P in Tables 4 and 5 is determined as follows:

$$P = \frac{6}{1 - \frac{{T}_{CSI - RS - neighbor}}{MGRP}} \qquad ( 16 )$$

In another example, the value of sharing factor P is determined such that the serving cell measurement is prioritized. For example, ⅔ of the measurement opportunity is for the serving cell and ⅓ of the measurement opportunity is for the neighbor cell. In this example, the value of sharing factor P in Tables 4 and 5 is determined as follows:

$$P = \frac{9}{1 - \frac{{T}_{CSI - RS - neighbor}}{MGRP}} \qquad ( 17 )$$

It is noted the prioritization of the serving cell measurement can include other ratios of the measurement opportunity between the serving cell and the neighbor cell. Also, in some aspects, the neighbor cell measurement can be prioritized. In another example, no requirement is defined and the behavior of the UE can be unspecified.

In some aspects, the CSI-RS resource(s) from the neighbor cell partially overlaps with a measurement gap (e.g., T_{CSI-RS-neighbor}<MGRP), the CSI-RS resource(s) from the neighbor cell partially overlaps with a SMTC occasion (e.g., T_{CSI-RS-neighbor}<T_{SMTCperiod}), and the SMTC occasion partially or fully overlaps with the measurement gap. In these examples, if the CSI-RS resource(s) from the neighbor cell does not overlap with SSB/CSI-RS resource(s) for the serving cell's L1-RSRP/SINR/BFD/CBD/RLM, then the value of sharing factor P in Tables 4 and 5 is determined as follows:

$$P = \frac{1}{1 - \frac{{T}_{CSI - RS - neighbor}}{min ( {T}_{SMTCperiod} , MGRP )}} \qquad ( 18 )$$

FIG. 5H illustrates another exemplary intra-frequency CSI-RS based L1 measurement in FR2, according to some aspects. In this example, the CSI-RS resource(s) from the neighbor cell partially overlaps with a measurement gap (e.g., T_{CSI-RS-neighbor}<MGRP), the CSI-RS resource(s) from the neighbor cell partially overlaps with a SMTC occasion (e.g., T_{CSI-RS-neighbor}<T_{SMTCperiod}), and the SMTC occasion partially or fully overlaps with the measurement gap. In this example, the CSI-RS resource(s) from the neighbor cell does not overlap with SSB/CSI-RS resource(s) for the serving cell's L1-RSRP/SINR/BFD/CBD/RLM.

As illustrated in FIG. 5H, measurement gap 571a and SMTC 574a overlap with serving cell's L1-RSRP/SINR/BFD/CBD/RLM 572a and CSI-RS resources 573a SMTC 574b overlaps with serving cell's L1-RSRP/SINR/BFD/CBD/RLM 572c and CSI-RS resources 573c. Measurement gap 571b overlaps with serving cell's L1-RSRP/SINR/BFD/CBD/RLM 572d and CSI-RS resources 573d. SMTC 574c overlaps with serving cell's L1-RSRP/SINR/BFD/CBD/RLM 572e and CSI-RS resources 573e. No measurement gap or SMTC overlaps with serving cell's L1-RSRP/SINR/BFD/CBD/RLM 572b and CSI-RS resources 573b.

In this example, CSI-RS resources 573 are configured for neighbor cell L1 measurement (e.g., L1-SINR measurement and/or L1-RSRP measurement) in FR2. In this example, serving cell's L1-RSRP/SINR/BFD/CBD/RLM 572 are configured for neighbor cell L1 measurement (e.g., L1-RSRP/SINR/BFD/CBD/RLM). The UE (e.g., UE 105) can use CSI-RS resources 573b to perform neighbor cell L1 measurement (e.g., L1-SINR measurement and/or L1-RSRP measurement) in FR2.

In this example, the partial overlap between the CSI-RS resources and the SMTC is illustrated in FIG. 5H as SMTC 574a-c overlapping with CSI-RS resources 573a, c, and e, respectively, but CSI-RS resources 573b and 573d not overlapping any SMTC. Also, in this example, the partial overlap between the CSI-RS resources and the measurement gap is illustrated in FIG. 5H as measurement gap 571a and 571b overlapping with CSI-RS resources 573a and 573d, respectively, but CSI-RS resources 573b, c, and e not overlapping any measurement gap.

In some aspects that the CSI-RS resource(s) from the neighbor cell partially overlaps with a measurement gap (e.g., T_{CSI-RS-neighbor}<MGRP), the CSI-RS resource(s) from the neighbor cell partially overlaps with a SMTC occasion (e.g., T_{CSI-RS-neighbor}<T_{SMTCperiod}), and the SMTC occasion partially or fully overlaps with the measurement gap, if the CSI-RS resource(s) from the neighbor cell overlaps with SSB/CSI-RS resource(s) for the serving cell's L1-RSRP/SINR/BFD/CBD/RLM, then one or more options can be used for determining the value of sharing factor P in Tables 4 and 5.

In one example, the value of sharing factor P is determined such that the measurement opportunity is divided (e.g., equally split) between the serving cell and the neighbor cell. For example, the value of sharing factor P in Tables 4 and 5 is:

$$P = \frac{2}{1 - \frac{{T}_{CSI - RS - neighbor}}{min ( {T}_{SMTCperiod} , MGRP )}} \qquad ( 19 )$$

In another example, the value of P is determined such that the serving cell measurement is prioritized. For example, ⅔ of the measurement opportunity is for the serving cell and ⅓ of the measurement opportunity is for the neighbor cell. In this example, the value of P in Tables 4 and 5 is determined as follows:

$$P = \frac{3}{1 - \frac{{T}_{CSI - RS - neighbor}}{min ( {T}_{SMTCperiod} , MGRP )}} \qquad ( 20 )$$

It is noted the prioritization of the serving cell measurement can include other ratios of the measurement opportunity between the serving cell and the neighbor cell. Also, in some aspects, the neighbor cell measurement can be prioritized. In another example, no requirement is defined and the behavior of the UE can be unspecified.

In some aspects, the CSI-RS resource(s) from the neighbor cell partially overlaps with a measurement gap, the CSI-RS resource(s) from the neighbor cell fully overlaps with a SMTC occasion (e.g., T_{CSI-RS-neighbor}=T_{SMTCperiod}), and the SMTC occasion partially overlaps with the measurement gap (e.g., T_{SMTCperiod}<MGRP). In these examples, if the CSI-RS resource(s) from the neighbor cell does not overlap with SSB/CSI-RS resource(s) for the serving cell's L1-RSRP/SINR/BFD/CBD/RLM, then the value of sharing factor P in Tables 4 and 5 is determined as follows:

$$P = \frac{{P}_{sharing factor}}{1 - \frac{{T}_{CSI - RS - neighbor}}{MGRP}} \qquad ( 21 )$$

FIG. 5I illustrates another exemplary intra-frequency CSI-RS based L1 measurement in FR2, according to some aspects. In this example, the CSI-RS resource(s) from the neighbor cell partially overlaps with a measurement gap, the CSI-RS resource(s) from the neighbor cell fully overlaps with a SMTC occasion (e.g., T_{CSI-RS-neighbor}=T_{SMTCperiod}), and the SMTC occasion partially overlaps with the measurement gap (e.g., T_{SMTCperiod}<MGRP). In this example, the CSI-RS resource(s) from the neighbor cell does not overlap with SSB/CSI-RS resource(s) for the serving cell's L1-RSRP/SINR/BFD/CBD/RLM.

As illustrated in FIG. 5I, measurement gap 581a and SMTC 584a overlap with serving cell's L1-RSRP/SINR/BFD/CBD/RLM 582a and CSI-RS resources 583a Measurement gap 581b and SMTC 584c overlap with serving cell's L1-RSRP/SINR/BFD/CBD/RLM 582c and CSI-RS resources 583c. Measurement gap 581c and SMTC 584e overlap with serving cell's L1-RSRP/SINR/BFD/CBD/RLM 582e and CSI-RS resources 583e. In this example, SMTC 584b overlaps with serving cell's L1-RSRP/SINR/BFD/CBD/RLM 582b and CSI-RS resources 583b. SMTC 584d overlaps with serving cell's L1-RSRP/SINR/BFD/CBD/RLM 582d and CSI-RS resources 583d. SMTC 584e overlaps with serving cell's L1-RSRP/SINR/BFD/CBD/RLM 582e and CSI-RS resources 583e.

In this example, CSI-RS resources 583 are configured for neighbor cell L1 measurement (e.g., L1-SINR measurement and/or L1-RSRP measurement) in FR2. In this example, serving cell's L1-RSRP/SINR/BFD/CBD/RLM 582 are configured for neighbor cell L1 measurement (e.g., L1-RSRP/SINR/BFD/CBD/RLM). The UE (e.g., UE 105) can use CSI-RS resources 583f to perform neighbor cell L1 measurement (e.g., L1-SINR measurement and/or L1-RSRP measurement) in FR2.

In this example, the full overlap between the CSI-RS resources and the SMTC is illustrated in FIG. 5H as SMTC 584a-f overlapping with CSI-RS resources 583a-f, respectively. Also, in this example, the partial overlap between the CSI-RS resources and the measurement gap is illustrated in FIG. 5I as measurement gap 581a-c overlapping with CSI-RS resources 583a, c, and e, respectively, but CSI-RS resources 583b, d, and f not overlapping any measurement gap.

In some aspects that the CSI-RS resource(s) from the neighbor cell partially overlaps with a measurement gap, the CSI-RS resource(s) from the neighbor cell fully overlaps with a SMTC occasion (e.g., T_{CSI-RS-neighbor}=T_{SMTCperiod}), and the SMTC occasion partially overlaps with the measurement gap (e.g., T_{SMTCperiod}<MGRP), if the CSI-RS resource(s) from the neighbor cell overlaps with SSB/CSI-RS resource(s) for the serving cell's L1-RSRP/SINR/BFD/CBD/RLM, then one or more options can be used for determining the value of sharing factor P in Tables 4 and 5.

In one example, the value of P is determined such that the measurement opportunity is divided (e.g., equally split) between the serving cell and the neighbor cell. In this example, the value of P in Tables 4 and 5 is determined as follows:

$$P = \frac{2. {P}_{sharing factor}}{1 - \frac{{T}_{CSI - RS - neighbor}}{MGRP}} \qquad ( 22 )$$

In another example, the value of sharing factor P is determined such that the serving cell measurement is prioritized. For example, ⅔ of the measurement opportunity is for the serving cell and ⅓ of the measurement opportunity is for the neighbor cell. In this example, the value of sharing factor P in Tables 4 and 5 is determined as follows:

$$P = \frac{3. {P}_{sharing factor}}{1 - \frac{{T}_{CSI - RS - neighbor}}{MGRP}} \qquad ( 23 )$$

It is noted the prioritization of the serving cell measurement can include other ratios of the measurement opportunity between the serving cell and the neighbor cell. Also, in some aspects, the neighbor cell measurement can be prioritized. In another example, no requirement is defined and the behavior of the UE can be unspecified.

Some aspects of this disclosure are directed to intra-frequency SSB based L1-RSRP measurement on the neighbor cell in FR2. In this example, UE 105 can use an intra-frequency SSB based L1-RSRP measurement period in FR2 to perform the intra-frequency SSB based L1-RSRP measurement(s). During the intra-frequency SSB based L1-RSRP measurement period, UE 105 can perform the L1-RSRP measurement(s) on the neighbor cell (e.g., base station 103) using one or more SSB resources.

Table 6 below illustrates one exemplary method to determine an intra-frequency SSB based L1-RSRP measurement period in FR2. In this example, UE 105 uses the intra-frequency L1-RSRP measurement period to perform L1-RSRP measurement in FR2 on the neighbor cell (e.g., base station 103) using one or more SSB resources.

TABLE 6
Measurement period T_{L1-RSRP}_{_{—}}_{Neighbor}_{_{—}}_{Measurement}_{_{—}}_{Period}_{_{—}}_{SSB} for FR2

| Configuration | T_{L1-RSRP}_{_{—}}_{Neighbor}_{_{—}}_{Measurement}_{_{—}}_{Period}_{_{—}}_{SSB} (ms) |
|---|---|
| Non-DRX | max(T_{Report}, ceil(M*P*N)*T_{SSB-neighbor}) |
| DRX cycle ≤ 320 ms | max(T_{Report}, ceil(1.5 K *M*P*N)*max(T_{DRX}, T_{SSB-neighbor})) |
| DRX cycle > 320 ms | ceil(M*P*N)*T_{DRX} |

According to some aspects, K and the measurement sample M are defined as discussed above. In some examples, N=8. However, the aspects of this disclosure are not limited to these examples, and other values of M and/or N can also be used.

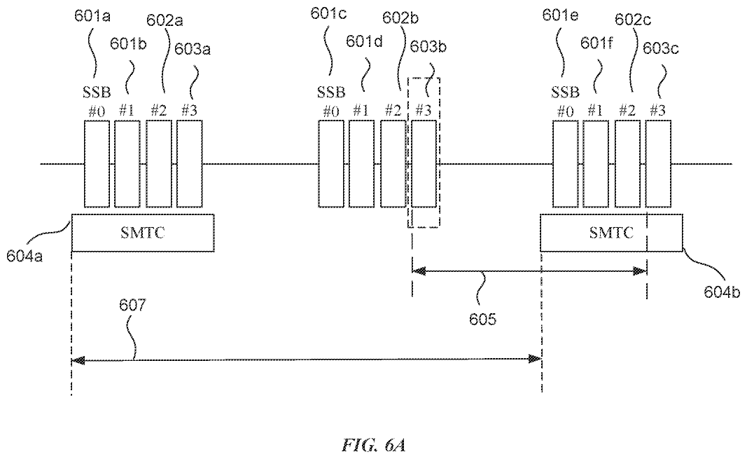

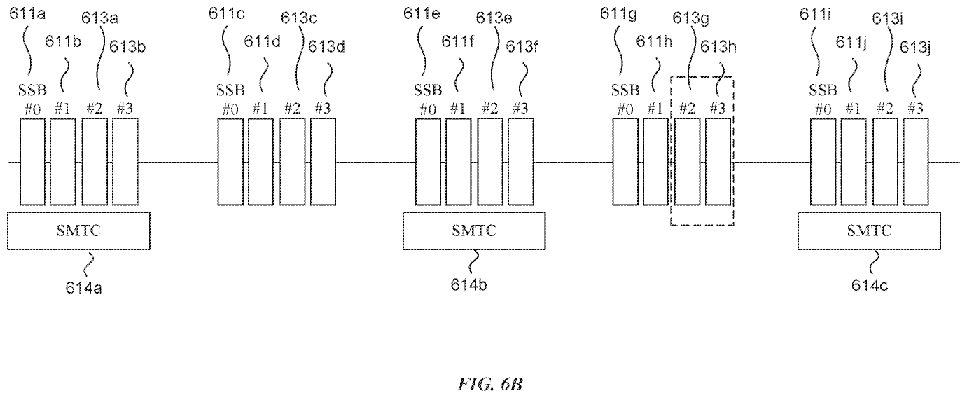

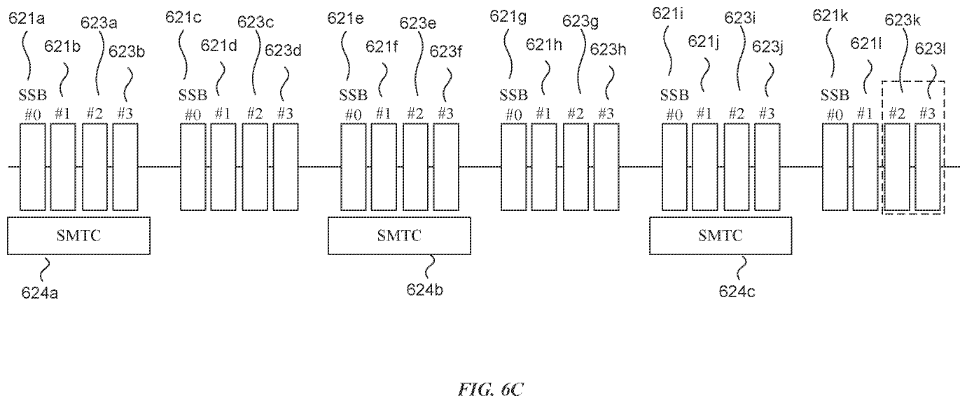

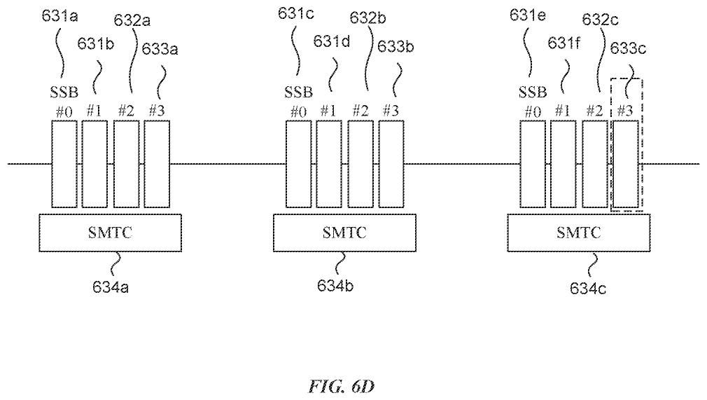

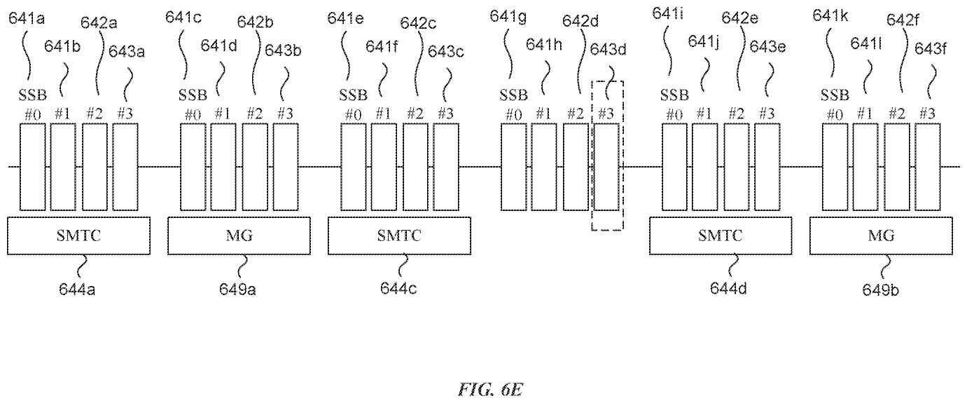

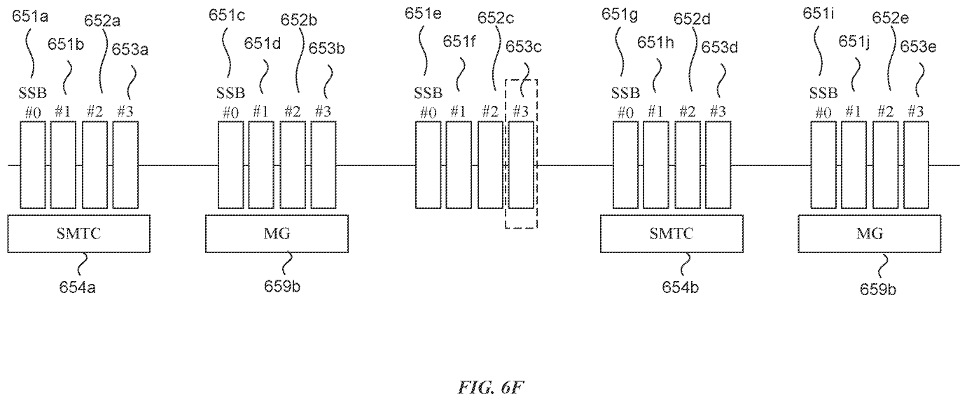

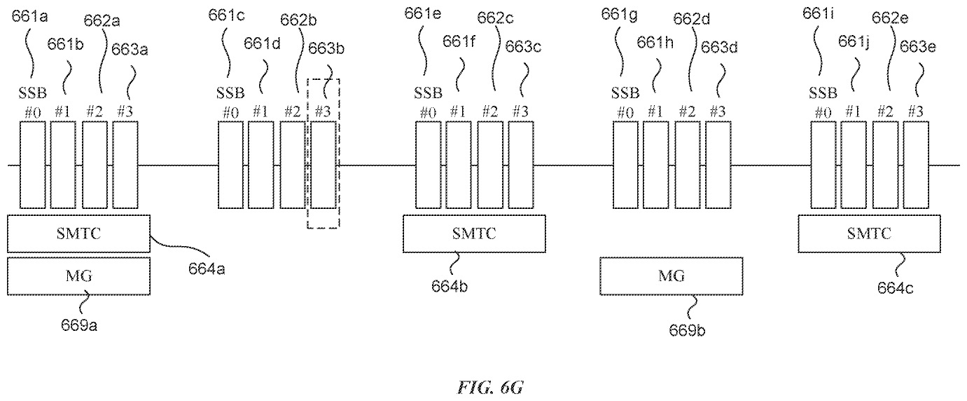

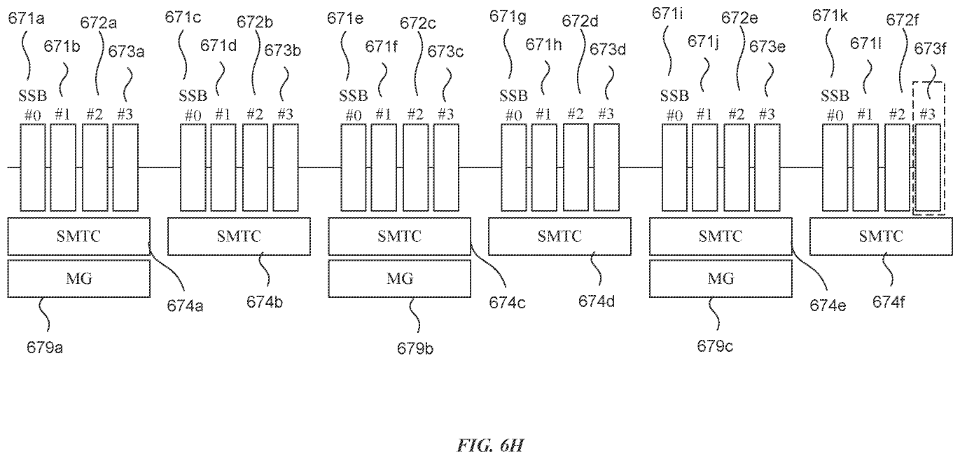

The value of sharing factor P in Table 6 can be determined based on different criteria as discussed below in more detail (for example, with respect to FIGS. 6A-6H).

In some aspects, the SSB resource(s) configured for L1-RSRP measurement in the neighbor cell does not overlap with a measurement gap and the SSB resource(s) configured for L1-RSRP measurement in the neighbor cell does not overlap with SSB configured for L1-RSRP measurement/BFD/CBD/RLM in the serving cell but partially overlaps with a SMTC occasion (T_{SSB-neighbor}<T_{SMTCperiod}). In these examples, the value of sharing factor P in Table 6 is determined as follows:

$$P = \frac{1}{1 - \frac{{T}_{SSB - neighbor}}{{T}_{SMTCperiod}}} \qquad ( 24 )$$

FIG. 6A illustrates one exemplary intra-frequency SSB based L1-RSRP measurement in FR2, according to some aspects. In this example, the SSB resource(s) configured for L1-RSRP measurement in the neighbor cell does not overlap with a measurement gap and the SSB resource(s) configured for L1-RSRP measurement in the neighbor cell does not overlap with SSB configured for L1-RSRP measurement/BFD/CBD/RLM in the serving cell but partially overlaps with a SMTC occasion (T_{SSB-neighbor}<T_{SMTCperiod}).

In this example, the partial overlap between the SSB resource(s) configured for L1-RSRP measurement in the neighbor cell and the SMTC occasion is illustrated in FIG. 6A as SMTC 604a and 604b overlapping with SSB resources 603a and 603c, respectively, and SSB resource 603b not overlapping with any SMTC.

In this example, SSB resources 601a-f (e.g., SSB resources #0 and 1) are configured for Layer 3 (L3) measurement. SSB resources 602a-c (e.g., SSB resources #2) are configured for serving cell L1 measurement. And SSB resources 603a-c (e.g., SSB resources #3) are configured for neighbor cell L1 measurement.

In this example, the UE (e.g., UE 105) can use SSB resource 603b to perform neighbor cell L1 measurement (e.g., L1-RSRP measurement) in FR2.

Time interval 605 can indicate the periodicity of SSB resource(s) configured for L1-RSRP measurement in FR2 (e.g., T_{SSB-neighbor}) in the neighbor cell. Similarly, time interval 607 can indicate the SMTC period (e.g., T_{SMTCperiod}).

In some aspects, the SSB resource(s) configured for L1-RSRP measurement in the neighbor cell does not overlap with a measurement gap, the SSB resource(s) configured for L1-RSRP measurement in the neighbor cell overlaps with SSB configured for L1-RSRP measurement/BFD/CBD/RLM in the serving cell and partially overlaps with a SMTC occasion (T_{SSB-neighbor}<T_{SMTCperiod}). In these examples, in one option, the measurement opportunity is divided (e.g., equally split) between the serving cell and the neighbor cell. In this example, the value of sharing factor P in Table 6 is determined as:

$$P = \frac{2}{1 - \frac{{T}_{SSB - neighbor}}{{T}_{SMTCperiod}}} \qquad ( 25 )$$

FIG. 6B illustrates another exemplary intra-frequency SSB based L1-RSRP measurement in FR2, according to some aspects. In this example, the SSB resource(s) configured for L1-RSRP measurement in the neighbor cell does not overlap with a measurement gap, the SSB resource(s) configured for L1-RSRP measurement in the neighbor cell overlaps with SSB configured for L1-RSRP measurement/BFD/CBD/RLM in the serving cell and partially overlaps with a SMTC occasion (T_{SSB-neighbor}<T_{SMTCperiod}). In this example, the measurement opportunity is divided (e.g., equally split) between the serving cell and the neighbor cell.

In this example, the partial overlap between the SSB resource(s) configured for L1-RSRP measurement in the neighbor cell and the SMTC occasion is illustrated in FIG. 6B as SMTC 614a-c overlapping with SSB resources 613a, 613b, 613e, 613f, 613i, 613j, respectively, and SSB resources 613c, 613d, 613g, and 613h not overlapping with any SMTC. In this example, SSB resources 611a-j (e.g., SSB resources #0 and 1) are configured for Layer 3 (L3) measurement. SSB resources 613a-j (e.g., SSB resources #2 and 3) are configured for L1 measurement (e.g., L1-RSRP measurement) on both the serving cell and the neighbor cell.

In this example, the UE (e.g., UE 105) can use SSB resources 613g and 613h to perform neighbor cell L1 measurement (e.g., L1-RSRP measurement) in FR2. In this example, out of four SSB resource 613c, d, g, h for L1 measurement (e.g., L1-RSRP measurement) on both the serving cell and the neighbor cell, the UE use two SSB resources for L1 measurement (e.g., L1-RSRP measurement) on the neighbor cell.

In some aspects that the SSB resource(s) configured for L1-RSRP measurement in the neighbor cell does not overlap with a measurement gap, the SSB resource(s) configured for L1-RSRP measurement in the neighbor cell overlaps with SSB configured for L1-RSRP measurement/BFD/CBD/RLM in the serving cell and partially overlaps with a SMTC occasion (T_{SSB-neighbor}<T_{SMTCperiod}), another option is to prioritize the serving cell measurement opportunity over the neighbor cell measurement. In a non-limiting example, the value of sharing factor P in Table 6 is determined as follows:

$$P = \frac{3}{1 - \frac{{T}_{SSB - neighbor}}{{T}_{SMTCperiod}}} \qquad ( 26 )$$

In this example, ⅔ of the measurement opportunity is for the serving cell and ⅓ of the measurement opportunity is for the neighbor cell. It is noted the prioritization of the serving cell measurement can include other ratios of the measurement opportunity between the serving cell and the neighbor cell. Also, in some aspects, the neighbor cell measurement can be prioritized.

FIG. 6C illustrates another exemplary intra-frequency SSB based L1-RSRP measurement in FR2, according to some aspects. In this example, the SSB resource(s) configured for L1-RSRP measurement in the neighbor cell does not overlap with a measurement gap, the SSB resource(s) configured for L1-RSRP measurement in the neighbor cell overlaps with SSB configured for L1-RSRP measurement/BFD/CBD/RLM in the serving cell and partially overlaps with a SMTC occasion (T_{SSB-neighbor}<T_{SMTCperiod}). In this example, the serving call measurement is prioritized over the neighbor cell measurement.

In this example, the partial overlap between the SSB resource(s) configured for L1-RSRP measurement in the neighbor cell and the SMTC occasion is illustrated in FIG. 6C as SMTC 624a-c overlapping with SSB resources 623a, 623b, 623e, 623f, 623i, 623j, respectively, and SSB resources 623c, 623d, 623g, 623h, 623k, 623l not overlapping with any SMTC. In this example, SSB resources 621a-l (e.g., SSB resources #0 and 1) are configured for Layer 3 (L3) measurement. SSB resources 623a-l (e.g., SSB resources #2 and 3) are configured for L1 measurement (e.g., L1-RSRP measurement) on both the serving cell and the neighbor cell.

In this example, the UE (e.g., UE 105) can use SSB resources 623k and 623l to perform neighbor cell L1 measurement (e.g., L1-RSRP measurement) in FR2. In this example, out of six SSB resource 623c, d, g, h, k, l for L1 measurement (e.g., L1-RSRP measurement) on both the serving cell and the neighbor cell, the UE use two SSB resources for L1 measurement (e.g., L1-RSRP measurement) on the neighbor cell.

In some aspects that the SSB resource(s) configured for L1-RSRP measurement in the neighbor cell does not overlap with a measurement gap, the SSB resource(s) configured for L1-RSRP measurement in the neighbor cell overlaps with SSB configured for L1-RSRP measurement/BFD/CBD/RLM in the serving cell and partially overlaps with a SMTC occasion (T_{SSB-neighbor}<T_{SMTCperiod}), another option is to not define any requirement for this case. In this case, the behavior of the UE can be unspecified.

In some aspects, the SSB resource(s) configured for L1-RSRP measurement in the neighbor cell does not overlap with a measurement gap but the SSB resource(s) configured for L1-RSRP measurement in the neighbor cell fully overlaps with a SMTC occasion (T_{SSB-neighbor}=T_{SMTCperiod}). In some examples, if the SSB resource(s) configured for L1-RSRP measurement in the neighbor cell does not overlap with the SSB resource(s) configured for L1 measurement/BFD/CBD/RLM in the serving cell, the value of sharing factor P in Table 6 is determined as follows:

P=P_{sharing factor} (27)

FIG. 6D illustrates another exemplary intra-frequency SSB based L1-RSRP measurement in FR2, according to some aspects. In this example, the SSB resource(s) configured for L1-RSRP measurement in the neighbor cell does not overlap with a measurement gap but the SSB resource(s) configured for L1-RSRP measurement in the neighbor cell fully overlaps with a SMTC occasion (T_{SSB-neighbor}=T_{SMTCperiod}). In some examples, the SSB resource(s) configured for L1-RSRP measurement in the neighbor cell does not overlap with the SSB resource(s) configured for L1 measurement/BFD/CBD/RLM in the serving cell.

In this example, the full overlap between the SSB resource(s) configured for L1-RSRP measurement in the neighbor cell and the SMTC occasion is illustrated in FIG. 6D as SMTC 634a-c overlapping with SSB resources 633a-b, respectively. In this example, SSB resources 631a-f (e.g., SSB resources #0 and 1) are configured for Layer 3 (L3) measurement. SSB resources 632a-c SSB resources # 2) are configured for serving cell L1 measurement. And SSB resources 633a-c (e.g., SSB resources #3) are configured for neighbor cell L1 measurement. In this example, the UE can use SSB resource 633c to perform neighbor cell L1 measurement (e.g., L1-RSRP measurement) in FR2.

In some aspects that the SSB resource(s) configured for L1-RSRP measurement in the neighbor cell does not overlap with a measurement gap but the SSB resource(s) configured for L1-RSRP measurement in the neighbor cell fully overlaps with a SMTC occasion (T_{SSB-neighbor}=T_{SMTCperiod}), if the SSB resource(s) configured for L1-RSRP measurement in the neighbor cell overlaps with the SSB resource(s) configured for L1 measurement/BFD/CBD/RLM in the serving cell, then one or more options can be used for determining the value of P in Table 6.

In one example, the value of P in Table 6 is determined such that the measurement opportunity is divided (e.g., equally split) between the serving cell and the neighbor cell. In this example, the value of sharing factor P in Table 6 is determined as follows:

P=2*P_{sharing factor} (28)

In another example, the value of P in Table 6 is determined such that the serving cell measurement is prioritized. For example, ⅔ of the measurement opportunity is for the serving cell and ⅓ of the measurement opportunity is for the neighbor cell. In this example, the value of sharing factor P in Table 6 is determined as follows:

P=3*P_{sharing factor} (29)

It is noted the prioritization of the serving cell measurement can include other ratios of the measurement opportunity between the serving cell and the neighbor cell. Also, in some aspects, the neighbor cell measurement can be prioritized. In another example, no requirement is defined and the behavior of the UE can be unspecified.

In some aspects, the SSB resource(s) configured for L1-RSRP measurement in the neighbor cell partially overlaps with a measurement gap and the SSB resource(s) configured for L1-RSRP measurement in the neighbor cell partially overlaps with a SMTC occasion (T_{SSB-neighbor}<T_{SMTCperiod}) and (T_{SMTCperiod}≠MGRP or (T_{SMTCperiod}=MGRP and T_{CSI-RS-neighbor}<0.5*T_{SMTCperiod})). In some examples, if the SSB resource(s) configured for L1-RSRP measurement in the neighbor cell does not overlap with the SSB resource(s) configured for L1 measurement/BFD/CBD/RLM in the serving cell, the value of sharing factor P in Table 6 is determined as follows:

$$P = \frac{1}{1 - \frac{{T}_{SSB - neighbor}}{MGRP} - \frac{{T}_{SSB - neighbor}}{{T}_{SMTCperiod}}} \qquad ( 30 )$$

FIG. 6E illustrates another exemplary intra-frequency SSB based L1-RSRP measurement in FR2, according to some aspects. In this example, the SSB resource(s) configured for L1-RSRP measurement in the neighbor cell partially overlaps with a measurement gap and the SSB resource(s) configured for L1-RSRP measurement in the neighbor cell partially overlaps with a SMTC occasion. (T_{SSB-neighbor}<T_{SMTCperiod}) and (T_{SMTCperiod}≠MGRP or (T_{SMTCperiod}=MGRP and T_{CSI-RS-neighbor}<0.5*T_{SMTCperiod})). In some examples, the SSB resource(s) configured for L1-RSRP measurement in the neighbor cell does not overlap with the SSB resource(s) configured for L1 measurement/BFD/CBD/RLM in the serving cell.

In this example, the partial overlap between the SSB resource(s) configured for L1-RSRP measurement in the neighbor cell and the SMTC occasion is illustrated in FIG. 6E as SMTC 644a-c overlapping with SSB resources 643a, c, and e, respectively, and SSB resources 643b, d, and f not overlapping with any SMTC. Also, the partial overlap between the SSB resource(s) configured for L1-RSRP measurement in the neighbor cell and the measurement gap is illustrated in FIG. 6E as MG 649a and 649b overlapping with SSB resources 643b and 643f, respectively, and SSB resources 643a, c, d, and e not overlapping with any measurement gap. Also, as illustrated in FIG. 6F, SMTC occasion does not overlap with measurement gap.

In this example, SSB resources 641a-l SSB resources #0 and 1) are configured for Layer 3 (L3) measurement. SSB resources 642a-f (e.g., SSB resources #2) are configured for serving cell L1 measurement. And SSB resources 643a-f (e.g., SSB resources #3) are configured for neighbor cell L1 measurement.

In this example, the UE (e.g., UE 105) can use SSB resource 643d to perform neighbor cell L1 measurement (e.g., L1-RSRP measurement) in FR2.

In some aspects that the SSB resource(s) configured for L1-RSRP measurement in the neighbor cell partially overlaps with a measurement gap and the SSB resource(s) configured for L1-RSRP measurement in the neighbor cell partially overlaps with a SMTC occasion (T_{SSB-neighbor}<T_{SMTCperiod}) and (T_{SMTCperiod}≠MGRP or (T_{SMTCperiod}=MGRP and T_{CSI-RS-neighbor}<0.5*T_{SMTCperiod})), if the SSB resource(s) configured for L1-RSRP measurement in the neighbor cell overlaps with the SSB resource(s) configured for L1 measurement/BFD/CBD/RLM in the serving cell, then one or more options can be used for determining the value of P in Table 6.

In one example, the value of sharing factor P is determined such that the measurement opportunity is divided (e.g., equally split) between the serving cell and the neighbor cell. In this example, the value of sharing factor P in Table 6 is determined as:

$$P = \frac{2}{1 - \frac{{T}_{SSB - neighbor}}{MGRP} - \frac{{T}_{SSB - neighbor}}{{T}_{SMTCperiod}}} \qquad ( 31 )$$

In another example, the value of P is determined such that the serving cell measurement is prioritized. For example, ⅔ of the measurement opportunity is for the serving cell and ⅓ of the measurement opportunity is for the neighbor cell. In this example, the value of sharing factor P in Table 6 is determined as follows:

$$P = \frac{3}{1 - \frac{{T}_{SSB - neighbor}}{MGRP} - \frac{{T}_{SSB - neighbor}}{{T}_{SMTCperiod}}} \qquad ( 32 )$$

It is noted the prioritization of the serving cell measurement can include other ratios of the measurement opportunity between the serving cell and the neighbor cell. Also, in some aspects, the neighbor cell measurement can be prioritized. In another example, no requirement is defined and the behavior of the UE can be unspecified.

In some aspects, the SSB resource(s) configured for L1-RSRP measurement in the neighbor cell partially overlaps with a measurement gap, the SSB resource(s) configured for L1-RSRP measurement in the neighbor cell partially overlaps with a SMTC occasion (T_{SSB-neighbor}<T_{SMTCperiod}), the SMTC occasion does not overlap with the measurement gap, T_{SMTCperiod}=MGRP, and T_{SSB-neighbor}=0.5*T_{SMTCperiod}. In some examples, if the SSB resource(s) configured for L1-RSRP measurement in the neighbor cell does not overlap with the SSB resource(s) configured for L1 measurement/BFD/CBD/RLM in the serving cell, the value of sharing factor P in Table 6 is determined as follows:

$$P = \frac{{P}_{sharing factor}}{1 - \frac{{T}_{SSB - neighbor}}{MGRP}} \qquad ( 33 )$$

FIG. 6F illustrates another exemplary intra-frequency SSB based L1-RSRP measurement in FR2, according to some aspects. In this example, the SSB resource(s) configured for L1-RSRP measurement in the neighbor cell partially overlaps with a measurement gap, the SSB resource(s) configured for L1-RSRP measurement in the neighbor cell partially overlaps with a SMTC occasion (T_{SSB-neighbor}<T_{SMTCperiod}), the SMTC occasion does not overlap with the measurement gap, T_{SMTCperiod}=MGRP, and T_{SSB-neighbor}=0.5*T_{SMTCperiod}. In some examples, the SSB resource(s) configured for L1-RSRP measurement in the neighbor cell does not overlap with the SSB resource(s) configured for L1 measurement/BFD/CBD/RLM in the serving cell.

In this example, the partial overlap between the SSB resource(s) configured for L1-RSRP measurement in the neighbor cell and the SMTC occasion is illustrated in FIG. 6F as SMTC 654a and 654b overlapping with SSB resources 653a and 653d, respectively, and SSB resources 653b, c, and e not overlapping with any SMTC. Also, the partial overlap between the SSB resource(s) configured for L1-RSRP measurement in the neighbor cell and the measurement gap is illustrated in FIG. 6F as MG 659a and 659b overlapping with SSB resources 653b and 643e, respectively, and SSB resources 653a, c, and d not overlapping with any measurement gap. Also, as illustrated in FIG. 6F, SMTC occasion does not overlap with measurement gap.

In this example. SSB resources 651a-j (e.g., SSB resources #0 and 1) are configured for Layer 3 (L3) measurement. SSB resources 652a-e (e.g., SSB resources #2) are configured for serving cell L1 measurement. And SSB resources 653a-e (e.g., SSB resources #3) are configured for neighbor cell L1 measurement.

In this example, the UE (e.g., UE 105) can use SSB resource 653c to perform neighbor cell L1 measurement (e.g., L1-RSRP measurement) in FR2.

In some aspects that the SSB resource(s) configured for L1-RSRP measurement in the neighbor cell partially overlaps with a measurement gap, the SSB resource(s) configured for L1-RSRP measurement in the neighbor cell partially overlaps with a SMTC occasion (T_{SSB-neighbor}<T_{SMTCperiod}), the SMTC occasion does not overlap with the measurement gap, T_{SMTCperiod}=MGRP, and T_{SSB-neighbor}=0.5*T_{SMTCperiod}, if the SSB resource(s)configured for L1-RSRP measurement in the neighbor cell overlaps with the SSB resource(s) configured for L1 measurement/BFD/CBD/RLM in the serving cell, then one or more options can be used for determining the value of sharing factor P in Table 6.

In one example, the value of P in Table 6 is determined such that the measurement opportunity is divided (e.g., equally split) between the serving cell and the neighbor cell. In this example, the value of P in Table 6 is determined as follows:

$$P = \frac{2. {P}_{sharing factor}}{1 - \frac{{T}_{SSB - neighbor}}{MGRP}} \qquad ( 34 )$$

In another example, the value of P in Table 6 is determined such that the serving cell measurement is prioritized. For example, ⅔ of the measurement opportunity is for the serving cell and ⅓ of the measurement opportunity is for the neighbor cell. In this example, the value of sharing factor P in Table 6 is determined as follows:

$$P = \frac{3. {P}_{sharing factor}}{1 - \frac{{T}_{SSB - neighbor}}{MGRP}} \qquad ( 35 )$$

It is noted the prioritization of the serving cell measurement can include other ratios of the measurement opportunity between the serving cell and the neighbor cell. Also, in some aspects, the neighbor cell measurement can be prioritized. In another example, no requirement is defined and the behavior of the UE can be unspecified.

In some aspects, the SSB resource(s) configured for L1-RSRP measurement in the neighbor cell partially overlaps with a measurement gap (e.g., T_{SSB-neighbor}=MGRP), the SSB resource(s) configured for L1-RSRP measurement in the neighbor cell partially overlaps with a SMTC occasion (T_{SSB-neighbor}<T_{SMTCperiod}), and the SMTC occasion partially or fully overlaps with the measurement gap. In some examples, if the SSB resource(s) configured for L1-RSRP measurement in the neighbor cell does not overlap with the SSB resource(s) configured for L1 measurement/BFD/CBD/RLM in the serving cell, the value of sharing factor P in Table 6 is determined as follows:

$$P = \frac{1}{1 - \frac{{T}_{SSB - neighbor}}{min ( {T}_{SMTCperiod} , MGRP )}} \qquad ( 36 )$$

FIG. 6G illustrates another exemplary intra-frequency SSB based L1-RSRP measurement in FR2, according to some aspects. In this example, the SSB resource(s) configured for L1-RSRP measurement in the neighbor cell partially overlaps with a measurement gap (e.g., T_{SSB-neighbor}<MGRP), the SSB resource(s) configured for L1-RSRP measurement in the neighbor cell partially overlaps with a SMTC occasion (T_{SSB-neighbor}<T_{SMTCperiod}), and the SMTC occasion partially or fully overlaps with the measurement gap. In some examples, the SSB resource(s) configured for L1-RSRP measurement in the neighbor cell does not overlap with the SSB resource(s) configured for L1 measurement/BFD/CBD/RLM in the serving cell.

In this example, the partial overlap between the SSB resource(s) configured for L1-RSRP measurement in the neighbor cell and the SMTC occasion is illustrated in FIG. 6G as SMTC 664a-c overlapping with SSB resources 663a, c, and e, respectively, and SSB resources 663b and 663d not overlapping with any SMTC. Also, the partial overlap between the SSB resource(s) configured for L1-RSRP measurement in the neighbor cell and the measurement gap is illustrated in FIG. 6G as MG 669a and 669b overlapping with SSB resources 663a and 663d, respectively, and SSB resources 663b, c, and e not overlapping with any measurement gap. Also, the partial overlap between the SMTC occasion and measurement gap is illustrated in FIG. 6G as SMTC 664a overlapping with MG 669 and SMTC 664b and SMTC 664c not overlapping with any measurement gap.

In this example, SSB resources 661a-j (e.g., SSB resources #0 and 1) are configured for Layer 3 (L3) measurement. SSB resources 662a-e (e.g., SSB resources #2) are configured for serving cell L1 measurement. And SSB resources 663a-e (e.g., SSB resources #3) are configured for neighbor cell L1 measurement.

In this example, the UE (e.g., UE 105) can use SSB resource 663b to perform neighbor cell L1 measurement (e.g., L1-RSRP measurement) in FR2.

In some aspects that the SSB resource(s) configured for L1-RSRP measurement in the neighbor cell partially overlaps with a measurement gap (e.g., T_{SSB-neighbor}<MGRP), the SSB resource(s) configured for L1-RSRP measurement in the neighbor cell partially overlaps with a SMTC occasion (T_{SSB-neighbor}<T_{SMTCperiod}), and the SMTC occasion partially or fully overlaps with the measurement gap, if the SSB resource(s) configured for L1-RSRP measurement in the neighbor cell overlaps with the SSB resource(s) configured for L1 measurement/BFD/CBD/RLM in the serving cell, then one or more options can be used for determining the value of sharing factor P in Table 6.

In one example, the value of P in Table 6 is determined such that the measurement opportunity is divided (e.g., equally split) between the serving cell and the neighbor cell. In this example, the value of sharing factor P in Table 6 is determined as follows:

$$P = \frac{2}{1 - \frac{{T}_{SSB - neighbor}}{min ( {T}_{SMTCperiod} , MGRP )}} \qquad ( 37 )$$

In another example, the value of P in Table 6 is determined such that the serving cell measurement is prioritized. For example, ⅔ of the measurement opportunity is for the serving cell and ⅓ of the measurement opportunity is for the neighbor cell. In this example, the value of sharing factor P in Table 6 is determined as follows:

$$P = \frac{3}{1 - \frac{{T}_{SSB - neighbor}}{min ( {T}_{SMTCperiod} , MGRP )}} \qquad ( 38 )$$

It is noted the prioritization of the serving cell measurement can include other ratios of the measurement opportunity between the serving cell and the neighbor cell. Also, in some aspects, the neighbor cell measurement can be prioritized. In another example, no requirement is defined and the behavior of the UE can be unspecified.

In some aspects, the SSB resource(s) configured for L1-RSRP measurement in the neighbor cell partially overlaps with a measurement gap, the SSB resource(s) configured for L1-RSRP measurement in the neighbor cell fully overlaps with a SMTC occasion (T_{SSB-neighbor}=T_{SMTCperiod}), and the SMTC occasion partially overlaps with the measurement gap (T_{SMTCperiod}<MGRP). In some examples, if the SSB resource(s) configured for L1-RSRP measurement in the neighbor cell does not overlap with the SSB resource(s) configured for L1 measurement/BFD/CBD/RLM in the serving cell, the value of sharing factor P in Table 6 is determined as follows:

$$P = \frac{{P}_{sharig factor}}{1 - \frac{{T}_{SSB - neighbor}}{MGRP}} \qquad ( 39 )$$

FIG. 6H illustrates another exemplary intra-frequency SSB based L1-RSRP measurement in FR2, according to some aspects. In this example, the SSB resource(s) configured for L1-RSRP measurement in the neighbor cell partially overlaps with a measurement gap, the SSB resource(s) configured for L1-RSRP measurement in the neighbor cell fully overlaps with a SMTC occasion (T_{SSB-neighbor}=T_{SMTCperiod}), and the SMTC occasion partially overlaps with the measurement gap (T_{SMTCperiod}<MGRP). In some examples, the SSB resource(s) configured for L1-RSRP measurement in the neighbor cell does not overlap with the SSB resource(s) configured for L1 measurement/BFD/CBD/RLM in the serving cell.

In this example, the full overlap between the SSB resource(s) configured for L1-RSRP measurement in the neighbor cell and the SMTC occasion is illustrated in FIG. 6H as SMTC 674a-f overlapping with SSB resources 673a-f, respectively. Also, the partial overlap between the SSB resource(s) configured for L1-RSRP measurement in the neighbor cell and the measurement gap is illustrated in FIG. 6H as MG 679a-c overlapping with SSB resources 673a, c, and e, respectively, and SSB resources 663b, d, and f not overlapping with any measurement gap. Also, the partial overlap between the SMTC occasion and measurement gap is illustrated in FIG. 6H as SMTC 674a, c, and e overlapping with MG 679a-c and SMTC 674b and SMTC 674d not overlapping with any measurement gap.

In this example, SSB resources 671a-l (e.g., SSB resources #0 and 1) are configured for Layer 3 (L3) measurement. SSB resources 672a-f (e.g., SSB resources #2) are configured for serving cell L1 measurement. And SSB resources 673a-f (e.g., SSB resources #3) are configured for neighbor cell L1 measurement.

In this example, the UE (e.g., UE 105) can use SSB resource 673f to perform neighbor cell L1 measurement (e.g., L1-RSRP measurement) in FR2.

In some aspects that the SSB resource(s) configured for L1-RSRP measurement in the neighbor cell partially overlaps with a measurement gap, the SSB resource(s) configured for L1-RSRP measurement in the neighbor cell fully overlaps with a SMTC occasion (T_{SSB-neighbor}=T_{SMTCperiod}), and the SMTC occasion partially overlaps with the measurement gap (T_{SMTCperiod}<MGRP), if the SSB resource(s) configured for L1-RSRP measurement in the neighbor cell overlaps with the SSB resource(s) configured for L1 measurement/BFD/CBD/RLM in the serving cell, then one or more options can be used for determining the value of P in Table 6.

In one example, the value of P is determined such that the measurement opportunity is divided (e.g., equally split) between the serving cell and the neighbor cell. In this example, the value of sharing factor P in Table 6 is determined as follows:

$$P = \frac{2. {P}_{sharig factor}}{1 - \frac{{T}_{SSB - neighbor}}{MGRP}} \qquad ( 40 )$$

In another example, the value of P is determined such that the serving cell measurement is prioritized. For example, ⅔ of the measurement opportunity is for the serving cell and ⅓ of the measurement opportunity is for the neighbor cell. In this example, the value of sharing factor P in Table 6 is determined as follows:

$$P = \frac{3. {P}_{sharig factor}}{1 - \frac{{T}_{SSB - neighbor}}{MGRP}} \qquad ( 41 )$$

It is noted the prioritization of the serving cell measurement can include other ratios of the measurement opportunity between the serving cell and the neighbor cell. Also, in some aspects, the neighbor cell measurement can be prioritized. In another example, no requirement is defined and the behavior of the UE can be unspecified.

According to some aspects, P_{sharing factor}=1 in equations (9)-(11), (21)-(23), (27)-(29), (33)-(35), and (39)-(41), if the CSI-RS from neighbor cell configured for L1 measurement (e.g., L1-SINR measurement and/or L1-RSRP measurement for equations (9)-(11), (21)-(23)) or if the SSB resource(s) from neighbor cell configured for L1 measurement (e.g., L1-RSRP measurement for equations (33)-(35), and (39)-(41)) outside measurement gap is:
not overlapped with the SSB symbols indicated by SSB-ToMeasure and 1 data symbol before each consecutive SSB symbols indicated by SSB-ToMeasure and 1 data symbol after each consecutive SSB symbols indicated by SSB-ToMeasure, given that SSB-ToMeasure is configured, and
not overlapped with the RSSI symbols indicated by ss-RSSI-Measurement and 1 data symbol before each RSSI symbol indicated by ss-RSSI-Measurement and 1 data symbol after each RSSI symbol indicated by ss-RSSI-Measurement, given that ss-RSSI-Measurement is configured.

Otherwise, P_{sharing factor}=3 in equations (9)-(11), (21)-(23), (27)-(29), (33)-(35), and (39)-(41).

Some aspects of this disclosure are directed to intra-frequency SSB based L1-SINR measurement on the neighbor cell in FR1 and/or FR2. In this example, the UE (e.g., UE 105) can use an intra-frequency SSB based L1-SINR measurement period in FR1 and/or FR2 to perform the intra-frequency SSB based L1-SINR measurement(s). During the intra-frequency SSB based L1-SNIR measurement period, UE 105 can perform the L1-SINR measurement(s) on the neighbor cell (e.g., base station 103) using one or more SSB resources in FR1 and/or FR2. Table 7 below illustrates one exemplary method to determine an intra-frequency SSB based L1-SINR measurement period. In some examples, the intra-frequency CSI-RS based L1-SINR measurement period is for intra-frequency SSB based L1-SINR measurement with dedicated IMR.

TABLE 7
Measurement period Tᵢₙₜᵣₐ_{_{—}}_{L1}_{_{—}}_{SINR}_{_{—}}_{Measurement}_{_{—}}_{Period}_{_{—}}_{SSB}_{_{—}}_{CMR}_{_{—}}_{IMR}

| Configuration | Tᵢₙₜᵣₐ_{_{—}}_{L1}_{_{—}}_{SINR}_{_{—}}_{Measurement}_{_{—}}_{Period}_{_{—}}_{SSB}_{_{—}}_{CMR}_{_{—}}_{IMR} (ms) |
|---|---|
| Non-DRX | max(T_{Report}, ceil(M*P*N)*T_{SSB-neighbor}) |
| DRX cycle ≤ 320 ms | max(T_{Report}, ceil(1.5 K *M*P*N)*max(T_{DRX}, T_{SSB-neighbor})) |
| DRX cycle > 320 ms | ceil(M*P*N)*T_{DRX} |

Some aspects of this disclosure are directed to intra-frequency L1-SINR measurement with CSI-RS CMR and dedicated IMR on the neighbor cell in FR1 and/or FR2. In this example, the UE (e.g., UE 105) can use an intra-frequency L1-SINR with CSI-RS CMR and dedicated IMR measurement period in FR1 and/or FR2 to perform the intra-frequency L1-SINR measurement(s). During the intra-frequency L1-SINR with CSI-RS CMR and dedicated IMR measurement period, UE 105 can perform the L1-SINR measurement(s) on the neighbor cell (e.g., base station 103) using one or more CSI-RS resource(s) in FR1 and/or FR2. Table 8 below illustrates one exemplary method to determine an intra-frequency L1-SINR with CSI-RS CMR and dedicated IMR measurement period.

TABLE 8
Measurement period Tᵢₙₜᵣₐ_{_{—}}_{L1}_{_{—}}_{SINR}_{_{—}}_{Measurement}_{_{—}}_{Period}_{_{—}}_{CSI-RS}_{_{—}}_{CMR}_{_{—}}_{IMR}

| Configuration | Tᵢₙₜᵣₐ_{_{—}}_{L1}_{_{—}}_{SINR}_{_{—}}_{Measurement}_{_{—}}_{Period}_{_{—}}_{CSI-RS}_{_{—}}_{CMR}_{_{—}}_{IMR} (ms) |
|---|---|
| Non-DRX | max(T_{Report}, ceil(M*P*N)*T_{CSI-neighbor}) |
| DRX cycle ≤ 320 ms | max(T_{Report}, ceil(1.5 K *M*P*N)*max(T_{DRX}, T_{CSI-neighbor})) |
| DRX cycle > 320 ms | ceil(M*P*N)*T_{DRX} |

In some examples, the conditions in Tables 7 and 8 are applicable provided that the CSI-RS resource(s) configured for interference measurement are 1-to-1 mapped to SSB resource(s) configured for channel measurement, with the same periodicity.

According to some aspects, M in Table 7 is the measurement sample. In some examples, for periodic or semi-persistent non-zero-power (NZP) CSI-RS or CSI-IM resource(s) as dedicated IMR, M=1 in Table 7 if higher layer parameter timeRestrictionForChannelMeasurements or timeRestrictionForInterferenceMeasurements is configured. Otherwise, M=3 in Table 7. In the examples where M=3. the UE can use 3 resources to perform the measurements and the UE can use an average of the measurements for the L1 measurement. In some examples, for aperiodic NZP-CSI-RS or CSI-IM resource as dedicated IMR, M=1 in Table 7. According to some aspects, K is defined as discussed above.

According to some aspects, the sharing factor P in Table 7 is defined as the maximum value between P_{CMR} and P_{IMR} (i.e.. P=max(P_{CMR}, P_{IMR})). In these examples, the value of P_{CMR} can be determined the same way as the sharing factor P for intra-frequency SSB based L1-RSRP measurement in neighbor cell (e.g., as discussed with respect to FIGS. 4 and 6A-6H and equations (2) and (24)-(41)) in which the occasions and period of the SSB for CMR is used instead. Also, in these examples, the value of P_{IMR} can be determined the same way as the sharing factor P for CSI-RS based L1-RSRP measurement in neighbor cell (e.g., as discussed with respect to FIGS. 3 and 5A-5I and equations (1) and (3)-(23)) in which the occasions and period of the NZP CSI-RS for NZP-IMR or CSI-IM for ZP-IMR is used instead.

In some examples, N in Table 7 is receiver (RX) beamforming scaling factor in FR2. in a non-limiting example, N=8.

According to some aspects, M in Table 8 is the measurement sample. In some examples, M=1 in Table 8 if aperiodic NZP-CSI-RS is used as CMR or dedicated IMR. In some examples, M=1 in Table 8 if aperiodic CSI-IMR is used as dedicated IMR. In some examples, M=1 in Table 8 if periodic and semi-persistent NZP-CSI-RS are used as CMR or dedicated IMR, and higher layer parameters timeRestrictionForChannelMeasurement or timeRestrictionForInterferenceMeasurements are configured. In some examples, M=1 in Table 8 if periodic and semi-persistent CSI-IM is used as dedicated IMR, and higher layer parameters timeRestrictionForChannelMeasurement or timeRestrictionForInterferenceMeasurements are configured.

If the above conditions are not satisfied, M=3 in Table 8, in some examples. In the examples where M=3, the UE can use 3 resources to perform the measurements and the UE can use an average of the measurements for the L1 measurement.

In some examples, the value of N in Table 8 can be determined by the network configuration. In a non-limiting example, the value of N in Table 8 can be the same as that defined in TS38.133 clause 9.8.4.3. However, other values can be defined for N.

According to some aspects, the sharing factor P in Table 8 is defined as the maximum value between P_{CMR} and P_{IMR} (i.e., P=max(P_{CMR}, P_{IMR})). Also, in these examples, the values of P_{CMR} and P_{IMR} can be determined the same way as the sharing factor P for CSI-RS based L1-RSRP measurement in neighbor cell (e.g., as discussed with respect to FIGS. 3 and 5A-5I and equations (1) and (3)-(23)) in which the occasions and period of the CSI-RS for CMR and NZP CSI-RS for NZP-IMR or CSI-IM for ZP-IMR are used instead, respectively.

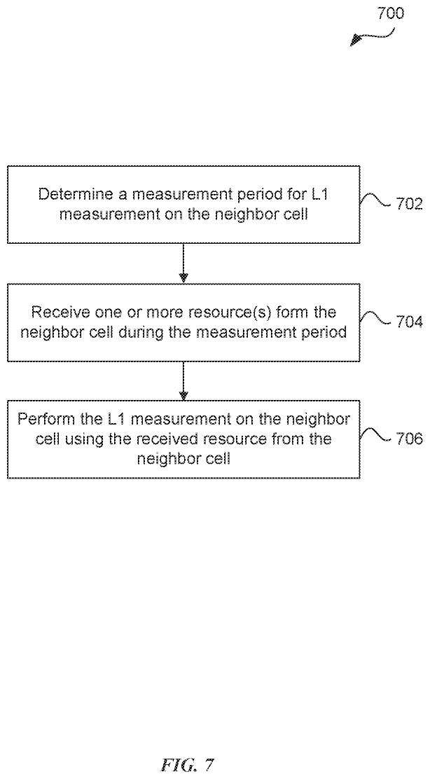

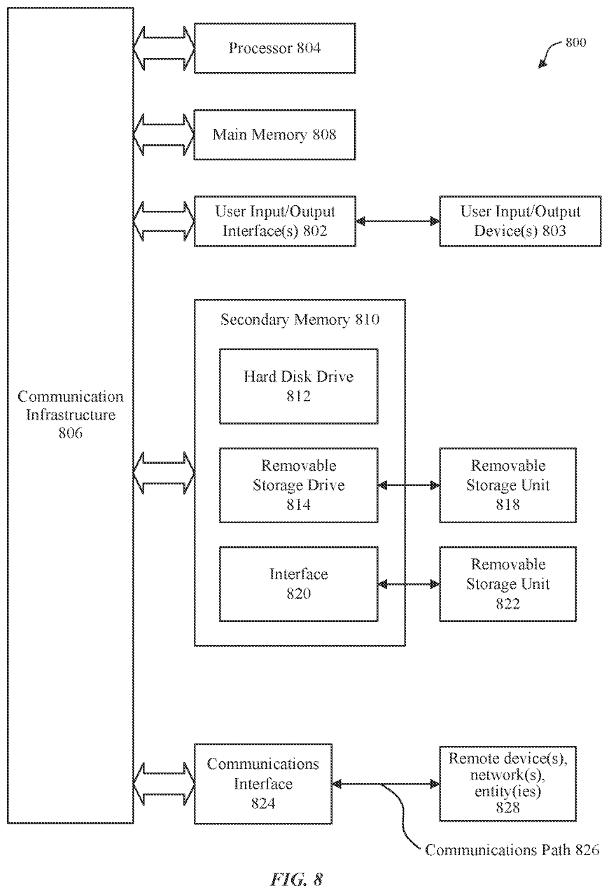

FIG. 7 illustrates an example method 700 for a system (for example a user equipment (UE)) supporting mechanisms for performing L1-RSRP measurements and/or L1-SINR measurements on a neighbor cell, according to some aspects of the disclosure. As a convenience and not a limitation, FIG. 7 may be described with regard to elements of FIGS. 1-4, 5A-5I, and 6A-6I. Method 700 may represent the operation of an electronic device (for example, UE 105 of FIG. 1) implementing mechanisms for performing L1-RSRP measurements and/or L1-SINR measurements on the neighbor cell. Method 700 may also be performed by system 200 of FIG. 2 and/or computer system 800 of FIG. 8. But method 700 is not limited to the specific aspects depicted in those figures and other systems may be used to perform the method as will be understood by those skilled in the art. It is to be appreciated that not all operations may be needed, and the operations may not be performed in the same order as shown in FIG. 7.

At 702, a measurement period for L1 measurement on the neighbor cell is determined. According to some aspects, the UE (e.g., UE 105) can receive one or more parameters associated with a serving cell (e.g., base station 101) and/or one or more parameters associated with the neighbor cell (e.g., base station 103). The UE can use the received parameters to determine the measurement period for L1 measurement on the neighbor cell. Additionally, or alternatively, the UE can receive the measurement period from the serving cell.

According to some aspects, the UE (e.g., UE 105) is configured to communicate with the serving cell (e.g., base station 101) and/or the neighbor cell (e.g., base station 103) to communicate its capabilities to the serving cell and/or the neighbor cell. Additionally, or alternatively, the UE can communicate with the serving cell and/or the neighbor cell to receive parameters associated with these cells and/or parameters associated with the networks of these cells.

In on example, before connecting to base station 101, UE 105 can search for a cell to attach. After completing the search, UE 105 can perform a Radio Resource Control (RRC) connection setup process. In one example, UE 105 can send an attach request to base station 101 and/or a mobility management entity (MME) (not shown) associated with base station 101. In some examples, the attach request can include an identifier of UE 105. In some aspects, if MME accepts the attach request, MME can send a setup request to, for example, base station 101. In some examples, after receiving the setup request, and if base station 101 does not know the capabilities of UE 105, base station 101 can send a request to UE 105 to request the capabilities of UE 105. According to some aspects, UE 105 can send its capabilities to base station 101. In response, base station 101 can send an RRC connection reconfiguration message back to UE 105. Then UE 105 can start data communication using base station 101.

According to some aspects, during the exemplary initial communication discussed above (or any other initial access), UE 105 can receive parameters associated with the serving cell and/or parameters associated with the network of the serving cell. In some examples, these parameter can include, but are not limited to, parameters associated with the serving cell's measurement gap (e.g., duration of a measurement gap, measurement gap period, etc.) In some examples, these parameter can include, but are not limited to, parameters associated with SMTC (e.g., the duration of an SMTC occasion, the SMTC period, etc.) In some examples, these parameter can include, but are not limited to, parameters associated with SSB resource(s) configured for L1 measurement (e.g., L1-SINR and/or L1-RSPR) on the serving cell (e.g., the duration of SSB resource(s) configured for L1 measurement on the serving cell, the period of the SSB resource(s) configured for L1 measurement on the serving cell, etc.) In some examples, these parameter can include, but are not limited to, parameters associated with CSI-RS resource(s) configured for L1 measurement (e.g., L1-SINR and/or L1-RSPR) on the serving cell (e.g., the duration of CSI-RS resource(s) configured for L1 measurement on the serving cell, the period of the CSI-RS resource(s) configured for L1 measurement on the serving cell, etc.) In some examples, these parameter can include other parameter such as, but not limited to, density (D), measurement sample, and the like.

Additionally, or alternatively, the UE can receive parameters associated with the neighbor cell and/or parameters associate with the network of the neighbor cell. The UE can receive these parameters from the neighbor cell while the UE is connected to the serving cell. According to some aspects, the parameters from the neighbor cell can include, but are not limited to, parameters associated with SSB resource(s) configured for L1 measurement (e.g., L1-SINR and/or L1-RSPR) on the neighbor cell (e.g., the duration of SSB resource(s) configured for L1 measurement on the neighbor cell, the period of the SSB resource(s) configured for L1 measurement on the neighbor cell, etc.) In some examples, the parameters from the neighbor cell can include, but are not limited to, parameters associated with CSI-RS resource(s) configured for L1 measurement (e.g., L1-SINR and/or L1-RSPR) on the neighbor cell (e.g., the duration of CSI-RS resource(s) configured for L1 measurement on the neighbor cell, the period of the CSI-RS resource(s) configured for L1 measurement on the neighbor cell, etc.) The parameters from the neighbor cell can include other parameters.

According to some aspects, the UE can use the parameters received from the serving cell and/or the neighbor cell to determine the measurement period for L1 measurement on the neighbor cell as discussed in detail above. Additionally, or alternatively, the UE can receive, from the serving cell, the measurement period for measurement on the neighbor cell.

In some examples, the measurement period for L1 measurement on the neighbor cell can include T_{intra_L1-SINR_Measurement_Period_CSI-RS_CMR_Only} for FR1 discussed above. In some examples, the measurement period for L1 measurement on the neighbor cell can include T_{L1-RSRP_Neighbor_Measurement_Period_CSI-RS} for FR1 discussed above. In some examples, the measurement period for L1 measurement on the neighbor cell can include T_{L1-RSRP_Neighbor_Measurement_Period_SSB} for FR1 discussed above. In some examples, the measurement period for L1 measurement on the neighbor cell can include T_{intra_L1-SINR_Measuremmt_Period_CMR-Only} for FR2 discussed above. In some examples, the measurement period for L1 measurement on the neighbor cell can include T_{L1_RSRP_Neighbor_Measurement_Period_CSI-RS} for FR2 discussed above. In some examples, the measurement period for L1 measurement on the neighbor cell can include T_{L1_RSRP_Neighbor_Measurement_Period_SSB} for FR2 discussed above. In some examples, the measurement period for L1 measurement on the neighbor cell can include T_{intra_L1_SINR_Measurement_Period_CSI-RS_CMR_IMR} discussed above. However, the aspects of this disclosure are not limited to these examples and can include other measurement periods.

At 704, one or more resource(s) are received from the neighbor cell during the measurement period. For example, the UE can receive one or more resources from the neighbor cell. In some examples, the resource(s) from the neighbor cell includes CSI-RS resource(s) from the neighbor cell and/or SSB resource(s) from the neighbor cell.

At 706, the L1 measurement is performed on the neighbor cell using the received resource from the neighbor cell. For example, the UE performs the L1 measurement on the neighbor cell using the received resource from the neighbor cell. In some examples, the L1 measurements can include measurements at beam level and can include measurements for procedures for which the UE can react with minimal delay. As discussed above, the L1 measurements can include L1-RSRP measurements on the neighbor cell and/or L1-SINR measurements on the neighbor cell.

In some examples, the L1-SINR measurement or the L1-RSRP measurement on the neighbor cell is performed in FR1. Additionally, or alternatively, the L1-SINR measurement or the L1-RSRP measurement on the neighbor cell is performed in FR2.

In some examples, the resource(s) received from the neighbor cell in 702 is CSI-RS resource(s). In response to the CSI-RS resource(s) from the neighbor cell overlapping with a SSB resource or a CSI-RS resource from the serving cell for an L1 measurement on the serving cell, the measurement period is configured such that a measurement opportunity is divided (e.g., equally divided) between the L1 measurement on the neighbor cell and the L1 measurement on the serving cell.

In some examples, in response to the CSI-RS resource(s) from the neighbor cell overlapping with the SSB resource or the CSI-RS resource from the serving cell for an L1 measurement on the serving cell, the measurement period is configured such that a measurement opportunity is divided to prioritize the L1 measurement on the serving cell over the L1 measurement on the neighbor cell.

In some examples, the measurement period is configured such that the L1 measurement on the neighbor cell is performed in 706 in a time period outside of a measurement gap associated with the serving cell.

In some examples, the measurement period is configured such that the L1 measurement on the neighbor cell is performed in 706 in a time period outside of a SMTC associated with the serving cell. In some examples, the resource(s) received from the neighbor cell in 702 is CSI-RS resource(s). In response to the CSI-RS resource(s) overlapping with a SMTC associated with the serving cell, the measurement period is configured such that the L1 measurement in 706 is performed on the neighbor cell during an SMTC occasion of the SMTC associated with the serving cell.

In some examples, the measurement period is configured such that the L1 measurement on the neighbor cell in 706 is performed in a time period outside of a measurement gap and an SMTC associated with the serving cell.

In some examples, the measurement period is configured such the L1 measurement on the neighbor cell in 706 is performed in a time period overlapping with one of a measurement gap or an SMTC occasion associated with the serving cell.

In some examples, operation 706 can include performing L1-SINR measurement on the neighbor cell using CSI-RS resource(s) from the neighbor cell and using IMR and CMR. In some examples, operation 706 can include performing L1-SINR measurement on the neighbor cell using SSB resource(s) from the neighbor cell and using IMR and CMR.

In some examples, the resource(s) received from the neighbor cell in 702 is SSB resource(s). In response to the SSB resource(s) from the neighbor cell overlapping with an SSB resource from the serving cell for an L1-RSRP measurement on the serving cell, the measurement period is configured such that a measurement opportunity is divided (e.g., equally divided) between the L1-RSRP measurement on the neighbor cell and the L1-RSRP measurement on the serving cell. Additionally, or alternatively, in response to the SSB resource(s) from the neighbor cell overlapping with an SSB resource from the serving cell for an L1-RSRP measurement on the serving cell, the measurement period is configured such that a measurement opportunity is divided to prioritize the L1-RSRP measurement on the serving cell over the L1-RSRP measurement on the neighbor cell.

In some examples, in response to the SSB resource(s) (received from the neighbor cell in 702) overlapping with an SMTC associated with the serving cell, the measurement period is configured such thathat the L1-RSRP measurement on the neighbor cell is performed during an SMTC occasion of the SMTC associated with the serving cell.

Various aspects can be implemented, for example, using one or more computer systems, such as computer system 800 shown in FIG. 8. Computer system 800 can be any well-known computer capable of performing the functions described herein such as devices 101, 103, 105 of FIG. 1, or 200 of FIG. 2. Computer system 800 includes one or more processors (also called central processing units, or CPUs), such as a processor 804. Processor 804 is connected to a communication infrastructure 806 (e.g., a bus.) Computer system 800 also includes user input/output device(s) 803, such as monitors, keyboards, pointing devices, etc., that communicate with communication infrastructure 806 through user input/output interface(s) 802. Computer system 800 also includes a main or primary memory 808, such as random access memory (RAM). Main memory 808 may include one or more levels of cache. Main memory 808 has stored therein control logic (e.g., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 includes a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 reads from and/or writes to removable storage unit 818 in a well-known manner.

According to some aspects, secondary memory 810 may include other means, instrumentalities or other approaches for allowing computer programs and/or other instructions and/or data to be accessed by computer system 800. Such means, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include communication or network interface 824. Communication interface 824 enables computer system 800 to communicate and interact with any combination of remote devices, remote networks, remote entities, etc. (individually and collectively referenced by reference number 828). For example, communication interface 824 may allow computer system 800 to communicate with remote devices 828 over communications path 826, which may be wired and/or wireless, and may include any combination of LANs, WANs, the Internet, etc. Control logic and/or data may be transmitted to and from computer system 800 via communication path 826.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 800, main memory 808, secondary memory 810 and removable storage units 818 and 822, as well as tangible articles of manufacture embodying any combination of the foregoing. Such control logic, when executed by one or more data processing devices (such as computer system 800), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 8. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one aspect,” “an aspect,” “an example aspect,” or similar phrases, indicate that the aspect described may include a particular feature, structure, or characteristic, but every aspects may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. The breadth and scope of the disclosure should not be limited by any of the above-described exemplary aspects, but should be defined only in accordance with the following claims and their equivalents.

As described above, aspects of the present technology may include the gathering and use of data available from various sources, e.g., to improve or enhance functionality. The present disclosure contemplates that in some instances, this gathered data may include personal information data that uniquely identifies or can be used to contact or locate a specific person. Such personal information data can include demographic data, location-based data, telephone numbers, email addresses, Twitter ID's, home addresses, data or records relating to a user's health or level of fitness (e.g., vital signs measurements, medication information, exercise information), date of birth, or any other identifying or personal information. The present disclosure recognizes that the use of such personal information data, in the present technology, may be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology may be configurable to allow users to selectively “opt in” or “opt out” of participation in the collection of personal information data, e.g., during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure may broadly cover use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

1. An electronic device, comprising:
a transceiver configured to communicate with a serving cell and a neighbor cell; and
a processor communicatively coupled to the transceiver and configured to:
determine a measurement period for a Layer 1 (L1) measurement on the neighbor cell;
receive, using the transceiver, a resource from the neighbor cell during the measurement period; and
perform the L1 measurement on the neighbor cell using the received resource from the neighbor cell.

2. The electronic device of claim 1, wherein:
to perform the L1 measurement on the neighbor cell, the processor is configured to perform an L1 Signal-to-Noise and Interference Ratio (L1-SINR) measurement on the neighbor cell or an L1 Reference Signal Received Power (L1-RSRP) measurement on the neighbor cell, and
the resource from the neighbor cell comprises a Channel State Information Reference Signal (CSI-RS) resource from the neighbor cell.

3. The electronic device of claim 2, wherein to perform the L1 measurement on the neighbor cell, the processor is configured to perform the L1-SINR measurement or the L1-RSRP measurement on the neighbor cell in Frequency Range 1 (FR1).

4. The electronic device of claim 2, wherein to perform the L1 measurement on the neighbor cell, the processor is configured to perform the L1-SINR measurement or the L1-RSRP measurement on the neighbor cell in Frequency Range 2 (FR2).

5. The electronic device of claim 2, wherein in response to the CSI-RS resource from the neighbor cell overlapping with a Synchronization Signal Block (SSB) resource or a CSI-RS resource from the serving cell for an L1 measurement on the serving cell, the measurement period is configured such that a measurement opportunity is divided between the L1 measurement on the neighbor cell and the L1 measurement on the serving cell.

6. The electronic device of claim 2, wherein in response to the CSI-RS resource from the neighbor cell overlapping with a Synchronization Signal Block (SSB) resource or a CSI-RS resource from the serving cell for an L1 measurement on the serving cell, the measurement period is configured such that a measurement opportunity is divided to prioritize the L1 measurement on the serving cell over the L1 measurement on the neighbor cell.

7. The electronic device of claim 2, wherein the measurement period is configured such that the processor is configured to perform the L1 measurement on the neighbor cell in a time period outside of a measurement gap associated with the serving cell.

8. The electronic device of claim 2, wherein the measurement period is configured such that the processor is configured to perform the L1 measurement on the neighbor cell in a time period outside of a Synchronization Signal Block (SSB) based measurement timing configuration (SMTC) associated with the serving cell.

9. The electronic device of claim 2, wherein in response to CSI-RS resource overlapping with a Synchronization Signal Block (SSB) based measurement timing configuration (SMTC) associated with the serving cell, the measurement period is configured such that the processor is configured to perform the L1 measurement on the neighbor cell during an SMTC occasion of the SMTC associated with the serving cell.

10. The electronic device of claim 2, wherein the measurement period is configured such that the processor is configured to perform the L1 measurement on the neighbor cell in a time period outside of a measurement gap and a Synchronization Signal Block (SSB) based measurement timing configuration (SMTC) associated with the serving cell.

11. The electronic device of claim 2, wherein the measurement period is configured such that the processor is configured to perform the L1 measurement on the neighbor cell in a time period overlapping with one of a measurement gap or a Synchronization Signal Block (SSB) based measurement timing configuration (SMTC) occasion associated with the serving cell.

12. The electronic device of claim 1, wherein to perform the L1 measurement on the neighbor cell, the processor is configured to perform an L1 Signal-to-Noise and Interference Ratio (L1-SINR) measurement on the neighbor cell using a Channel State Information Reference Signal (CSI-RS) resource from the neighbor cell and using Interference Measurement Resource (IMR) and Channel Measurement Resource (CMR).

13. The electronic device of claim 1, wherein to perform the L1 measurement on the neighbor cell, the processor is configured to perform an L1 Signal-to-Noise and Interference Ratio (L1-SINR) measurement on the neighbor cell using a Synchronization Signal Block (SSB) resource from the neighbor cell and using Interference Measurement Resource (IMR) and Channel Measurement Resource (CMR).

14. The electronic device of claim 1, wherein:
to perform the L1 measurement on the neighbor cell, the processor is configured to perform a L1 Reference Signal Received Power (L1-RSRP) measurement on the neighbor cell, and
the resource from the neighbor cell comprises a Synchronization Signal Block (SSB) resource from the neighbor cell.

15. The electronic device of claim 14, wherein to perform the L1 measurement on the neighbor cell, the processor is configured to perform the L1-RSRP measurement on the neighbor cell in Frequency Range 1 (FR1).

16. The electronic device of claim 14, wherein to perform the L1 measurement on the neighbor cell, the processor is configured to perform the L1-RSRP measurement on the neighbor cell in Frequency Range 2 (FR2).

17. The electronic device of claim 14, wherein in response to the SSB resource from the neighbor cell overlapping with an SSB resource from the serving cell for an L1-RSRP measurement on the serving cell, the measurement period is configured such that a measurement opportunity is divided between the L1-RSRP measurement on the neighbor cell and the L1-RSRP measurement on the serving cell.

18. The electronic device of claim 14, wherein in response to the SSB resource from the neighbor cell overlapping with an SSB resource from the serving cell for an L1-RSRP measurement on the serving cell, the measurement period is configured such that a measurement opportunity is divided to prioritize the L1-RSRP measurement on the serving cell over the L1-RSRP measurement on the neighbor cell.

19.-23. (canceled)

24. A method, comprising:
determining, by a user equipment (UE) that communicates with a serving call, a measurement period for a Layer 1 (L1) measurement on a neighbor cell;
receiving, by the UE, a resource from the neighbor cell during the measurement period; and
performing, by the UE, the L1 measurement on the neighbor cell using the received resource from the neighbor cell.

25. A non-transitory computer-readable medium storing instructions that, when executed by a processor of a user equipment (UE) that communicates with a serving cell, cause the processor to perform operations, the operations comprising:
determining a measurement period for a Layer 1 (L1) measurement on a neighbor cell;
receiving a resource from the neighbor cell during the measurement period; and
performing the L1 measurement on the neighbor cell using the received resource from the neighbor cell.
